(19) United States
(12) Patent Application Publication
(10) Pub. No.: US 2022/0002546 A1
(43) Pub. Date: Jan. 6, 2022

(54) PHOTO-CURABLE ORGANOPOLYSILOXANE COMPOSITION, AND CURED PRODUCT THEREOF

(71) Applicants: DOW TORAY CO., LTD., Shinagawa-ku, Tokyo (JP); DOW GLOBAL TECHNOLOGIES LLC, Midland, MI (US)

(72) Inventors: Eun Sil JANG, Midland, MI (US); Takuya OGAWA, Shinagawa-ku, Tokyo (JP); Tadashi OKAWA, Shinagawa-ku, Tokyo (JP)

(21) Appl. No.: 17/281,669

(22) PCT Filed: Sep. 26, 2019
(86) PCT No.: PCT/US2019/053150

§ 371 Date: Mar. 31, 2021

Related U.S. Application Data
(60) Provisional application No. 62/739,469, filed on Oct. 1, 2018.

(51) Int. Cl. C08L 83/04; C08G 77/20; C08G 77/28

(52) U.S. Cl. CPC C08L 83/04; C08G 77/28; C08G 77/20

(57) ABSTRACT

A photo-curable organopolysiloxane composition is provided. The photo-curable organopolysiloxane composition comprises: (A) 100 parts by mass of a photo-curable organopolysiloxane; and (B) about 0.01 to about 5.0 parts by mass of an organosilicon compound having at least one photo-active organic group and having at most about 200 silicon atoms per molecule, wherein the organosilicon compound is activated when it is exposed to light of a wavelength of from 300 to 420 nm. The photo-curable organopolysiloxane composition exhibits good storage ability and can be cured by exposing light of a wavelength of from 300 to 420 nm, and can form a cured product exhibiting good transparency.

### CROSS-REFERENCE TO RELATED APPLICATIONS

This application claims priority to and all advantages of U.S. Provisional Patent Application No. 62/739,469 filed on 1 Oct. 2018, the content of which is incorporated herein by reference.

### TECHNICAL FIELD

The present invention relates to a photo-curable organopolysiloxane composition and a cured product thereof.

### BACKGROUND ART

Photo-curable organopolysiloxane compositions are used as adhesives and pressure sensitive adhesives for enhancing the visibility of an optical display. In recent years, thermoplastic resins such as polycarbonates have been used for display surface covers for safety reasons, and there is demand for a photo-curable organopolysiloxane composition that cures by long wavelength light that is not absorbed by this type of thermoplastic resin (for example, visible light with a wavelength of 405 nm).

In general, the photocurable organopolysiloxane composition comprises a photoinitiator to improve its curability. As the photo-curable organopolysiloxane compositions, for example, Patent Document 1 describes a photo-curable organopolysiloxane composition comprising: a vinyl group-containing flowable organopolysiloxane, a vinyl group-containing organopolysiloxane resin, a mercaptoalkyl group-containing organopolysiloxane, and a photo-initiator such as 2-hydroxy-2-methyl-1-phenylpropan-1-one, and 1-(4-isopropylphenyl)-2-hydroxy-2-methylpropan-1-one; Patent Document 2 describes a photo-curable organopolysiloxane composition comprising: an alkenyl-containing polydiorganosiloxane, a mercapto functional polyorganosiloxane or a mercapto organic compound, and a photo-initiator such as benzophenone, acetonaphthone, acetophenone, benzoin methylether, benzoin isobutylether, 2,2-diethoxyacetophenone, 2-hydroxy-2-methyl-1-phenylpropan-1-one, and 1[4-isopropyl-phenyl]-2-hydroxy-2-methylpropanone; and Patent Document 3 describes a photocurable organopolysiloxane composition comprising: an organopolysiloxane having a silicon atom-bonded unsaturated aliphatic radical, an organopolysiloxane having a silicon atom-bonded mercaptoalkyl radical, and a photo-initiator such as 2-hydroxy-2-methylpropiophenone, and 2,4,6-trimethylbenzoyl diphenyl phosphine oxide.

However, these types of photo-initiators have poor compatibility with organopolysiloxanes, so that obtained photo-curable organopolysiloxane compositions have poor transparency and therefore, poor deep curing properties by irradiation of long wavelength light, resulting in insufficient curing.

### PRIOR ART DOCUMENTS

### Patent Documents

Patent Document 1: U.S. Pat. No. 4,935,455

Patent Document 2: U.S. Pat. No. 4,946,874

Patent Document 3: U.S. Pat. No. 5,158,988

### BRIEF SUMMARY OF INVENTION

### Technical Problem

An object of the present invention is to provide a photo-curable organopolysiloxane composition that is rapidly cured by irradiating with long wavelength light while providing excellent storage stability, in addition to providing a cured product that exhibits transparency.

### Solution to Problem

The photo-curable organopolysiloxane composition of the present invention comprises:

(A) 100 parts by mass of a photo-curable organopolysiloxane; and
(B) about 0.01 to about 5.0 parts by mass of an organosilicon compound having at least one photo-active organic group and having at most about 200 silicon atoms per molecule, wherein the organosilicon compound is activated when it is exposed to light of a wavelength of from 300 to 420 nm.

In various embodiments, component (A) is an organopolysiloxane having at least one photo-reactive organic group per molecule.

In various embodiments, the photo-reactive organic group in component (A) is an acryl group-containing organic group, a methacryl group-containing organic group, an alkenyl group, a mercapto group-containing organic group, or mixtures thereof.

In various embodiments, component (A) is a photo-curable organopolysiloxane selected from the group consisting of the following compositions (M1) to (M7):

### Composition (M1):

(A1) an organopolysiloxane having at least one of an acryl group-containing organic group and/or a methacryl group-containing organic group per molecule; and
(A2) an organopolysiloxane having at least one alkenyl group having 2 to 12 carbon atoms per molecule and free of a mercapto group-containing organic group, in an amount that the content of component (A2) is 0.1 to 50.0 parts by mass per 100 parts by mass of the sum of components (A1) and (A2).

### Composition (M2):

(A1) an organopolysiloxane having at least one of an acryl group-containing organic group and/or a methacryl group-containing organic group per molecule; and
(A3) an organocompound having at least one mercapto group-containing organic group per molecule, in an amount that the mercapto groups in component (A3) is 0 to 3 moles per 1 mole of the acryl group-containing organic groups and/or methacryl group-containing organic groups in component (A1).

### Composition (M3):

(A4) an organopolysiloxane having at least two alkenyl groups having 2 to 12 carbon atoms per molecule and free of a mercapto group-containing organic group; and
(A5) an organocompound having at least two mercapto group-containing organic groups per molecule, in an amount that the mercapto groups in component (A5) is 0.2 to 3 moles per 1 mole of the alkenyl groups in component (A4).

### Composition (M4):

(A1) an organopolysiloxane having at least one of an acryl group-containing organic group and/or a methacryl group-containing organic group per molecule;
(A2) an organopolysiloxane having at least one alkenyl group having 2 to 12 carbon atoms per molecule and free of a mercapto group-containing organic group; and
(A3) an organocompound having at least one mercapto group-containing organic group per molecule, in an amount that the mercapto groups in component (A3) is 0.1 to 3 moles per 1 mole of the sum of the acryl group-containing organic groups and/or methacryl group-containing organic groups in component (A1) and the alkenyl groups in component (A2).

### Composition (M5):

(A6) an organopolysiloxane having at least one of an acryl group-containing organic group and/or a methacryl group-containing organic group per molecule, having at least one alkenyl group per molecule, and free of a mercapto group-containing organic group; and
(A3) an organocompound having at least one mercapto group-containing organic group per molecule, in an amount that the mercapto groups in component (A3) is 0 to 3 moles per 1 mole of the sum of the acryl group-containing organic groups and/or methacryl group-containing organic groups and the alkenyl groups in component (A6).

### Composition (M6):

(A7) an organopolysiloxane having at least two alkenyl groups having 2 to 12 carbon atoms per molecule, and having at least two mercapto group-containing organic groups per molecule.

### Composition (M7):

(A8) an organopolysiloxane having at least one of an acryl group-containing organic group and/or a methacryl group-containing organic group per molecule, having at least one alkenyl group having 2 to 12 carbon atoms per molecule, and having at least one mercapto group-containing organic group per molecule.

In various embodiments, the photo-active organic group in component (B) is a group selected from the groups represented by the following formulae (a)-(q):

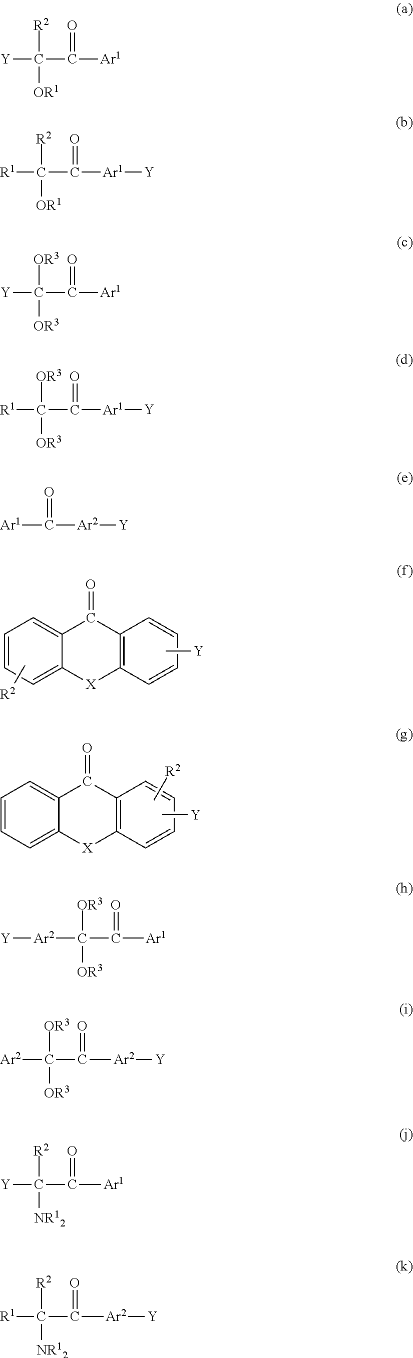

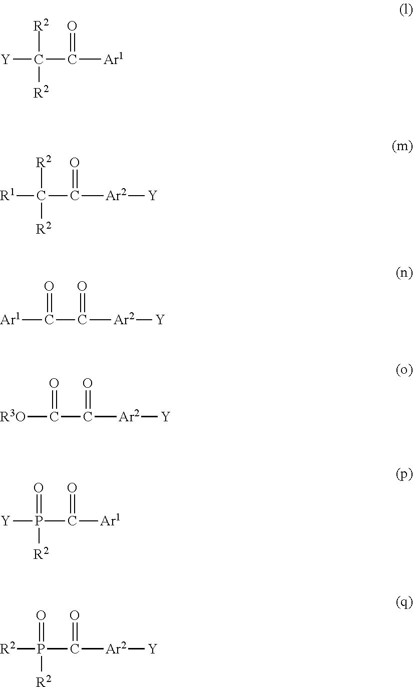

In the formulae, R¹ is a hydrogen atom or an alkyl group having 1 to 12 carbon atoms; R² is an alkyl group having 1 to 12 carbon atoms, an aryl group having 6 to 20 carbon atoms, an aralkyl group having 7 to 20 carbon atoms, a halogen atom-, an amino group- or a hydroxyl group-substituted alkyl group having 1 to 12 carbon atoms, a halogen atom-, an amino group- or a hydroxyl group-substituted aryl group having 6 to 20 carbon atoms, or a halogen atom; R³ is an alkyl group having 1 to 12 carbon atoms; Ar¹ is an aryl group having 6 to 20 carbon atoms, or a halogen atom-, an amino group- or a hydroxyl group-substituted aryl group having 6 to 20 carbon atoms; Ar² is an arylene group having 6 to 20 carbon atoms, or a halogen atom-, an amino group- or a hydroxyl group-substituted arylene group having 6 to 20 carbon atoms; X is an oxygen atom or a sulfur atom; and Y is a divalent bond connecting with a Si atom in component (B).

In various embodiments, the composition is an optical or an electrical, and pressure-sensitive adhesive, adhesive, or an encapsulant.

The cured product of the present invention is characterized by being obtained by exposing the photo-curable organopolysiloxane composition as described above to light of a wavelength of from 300 to 420 nm.

### Effects of Invention

The photo-curable organopolysiloxane composition of the present invention exhibits good storage ability and can be cured by exposing light of a wavelength of from 300 to 420 nm, and form a cured product exhibiting good transparency.

### DETAILED DESCRIPTION OF THE INVENTION

The terms “comprising” or “comprise” are used herein in their broadest sense to mean and encompass the notions of “including,” “include,” “consist(ing) essentially of,” and “consist(ing) of. The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples. The term “about” as used herein serves to reasonably encompass or describe minor variations in numerical values measured by instrumental analysis or as a result of sample handling. Such minor variations may be in the order of ±0-25, ±0-10, ±0-5, or ±0-2.5% of the numerical values. Further, the term “about” applies to both numerical values when associated with a range of values. Moreover, the term “about” may apply to numerical values even when not explicitly stated.

Generally, as used herein a hyphen “-” or dash “-” in a range of values is “to” or “through”; a “>” is “above” or “greater-than”; a “≥” is “at least” or “greater-than or equal to”; a “<” is “below” or “less-than”; and a “≤” is “at most” or “less-than or equal to.” On an individual basis, each of the aforementioned applications for patent, patents, and/or patent application publications, is expressly incorporated herein by reference in its entirety in one or more non-limiting embodiments.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

### <Photo-Curable Organopolysiloxane Composition>

First, the photo-curable organopolysiloxane composition of the present invention will be described in detail.

Component (A) is a photo-curable organopolysiloxane, and in various embodiments is an organopolysiloxane having at least one photo-reactive organic group per molecule. Examples of the photo-reactive organic groups include acryl group-containing organic groups, methacryl groups-containing organic groups, alkenyl groups, mercapto group-containing organic groups, and mixtures thereof.

Examples of the acryl or methacryl group-containing organic groups include acryloxymethyl groups, acryloxyethyl groups, acryloxypropyl groups, acryloxybutyl groups, acrylamidomethyl groups, acrylamidoethyl groups, acrylamidopropyl groups, acrylamidobutyl groups, methacryloxymethyl groups, methacryloxyethyl groups, methacryloxypropyl groups, methacryloxybutyl groups, methacrylamidomethyl groups, methacrylamidoethyl groups, methacrylamidopropyl groups, methacrylamidobutyl groups, acryloxypolyethylenoxy propyl groups, and methacryloxypolyethylenoxy propyl groups. In various embodiments, from the perspective of economics and reactivity, acryloxypropyl groups and methacryloxy propyl groups may be desirable.

Examples of the alkenyl groups include alkenyl groups having 2 to 12 carbon atoms such as vinyl groups, allyl groups, isopropenyl groups, butenyl groups, pentenyl groups, hexenyl groups, heptenyl groups, cyclohexenyl groups, octenyl groups, nonenyl groups, decenyl groups, undecenyl groups, and dodecenyl groups. In various embodiments, from the perspective of economics and reactivity, vinyl groups, allyl groups, hexenyl groups, and octenyl groups may be desirable.

Examples of the mercapto group-containing organic groups include mercaptoalkyl groups such as 3-mercaptopropyl groups, 4-mercaptobutyl groups, and 6-mercaptohexyl groups. In various embodiments, but from the perspective of economics and reactivity, 3-mercaptopropyl groups may be desirable.

Examples of groups bonded to the silicon atom other than the photo-reactive organic groups in component (A) include alkyl groups having 1 to 12 carbon atoms such as methyl groups, ethyl groups, propyl groups, butyl groups, pentyl groups, hexyl groups, heptyl groups, and octyl groups; aryl groups having 6 to 20 carbon atoms such as phenyl groups, tolyl groups, xylyl groups, and naphthyl groups; aralkyl groups having 7 to 20 carbon atoms such as benzyl groups, phenethyl groups, and 3-phenylpropyl groups; halogenated alkyl groups having 1 to 12 carbon atoms such as chloromethyl groups, 3-chloropropyl groups, 3,3,3-trifluoropropyl groups, and nonafluorobutylethyl groups. In various embodiments, from the perspective of economics, methyl groups and phenyl groups may be desirable. Furthermore, the silicon atom in component (A) may be bonded to a small amount of hydroxyl groups or alkoxy groups such as methoxy groups, ethoxy groups, n-propoxy groups, i-propoxy groups, n-butoxy groups, sec-butoxy groups, tert-butoxy groups and the like.

Examples of the molecular structure of component (A) include straight chain, cyclic, partially-branched straight chain, and branched. In various embodiments, at least one type of linear organopolysiloxane is used as component (A) from the viewpoint that it can impart sufficient strength to the obtained cured product. The viscosity at 25° C. of component (A) is not limited, but in various embodiments it is in a range of from about 1 to about 500,000 mPa·s, or optionally in a range of from about 1 to about 200,000 mPa·s. This is because if the viscosity of component (A) is above the lower limit of the range, the mechanical properties of the cured product obtained will be enhanced; on the other hand, if the viscosity is below the upper limit of the aforementioned range, the coatability of the composition obtained will be enhanced. Note that in the present specification, viscosity is the value measured using a type B viscometer according to ASTM D 1084 at 23±2° C.

In various embodiments, component (A) is a photo-curable organopolysiloxane selected from the group consisting of the following compositions (M1) to (M7):

### Composition (M1):

(A1) an organopolysiloxane having at least one of an acryl group-containing organic group and/or a methacryl group-containing organic group per molecule; and
(A2) an organopolysiloxane having at least one alkenyl group having 2 to 12 carbon atoms per molecule and free of a mercapto group-containing organic group, in an amount that the content of component (A2) is 0.1 to 50.0 parts by mass per 100 parts by mass of the sum of components (A1) and (A2).

### Composition (M2):

(A1) an organopolysiloxane having at least one of an acryl group-containing organic group and/or a methacryl group-containing organic group per molecule; and
(A3) an organocompound having at least one mercapto group-containing organic group per molecule, in an amount that the mercapto groups in component (A3) is 0 to 3 moles per 1 mole of the acryl group-containing organic groups and/or methacryl group-containing organic groups in component (A1).

### Composition (M3):

(A4) an organopolysiloxane having at least two alkenyl groups having 2 to 12 carbon atoms per molecule and free of a mercapto group-containing organic group; and
(A5) an organocompound having at least two mercapto group-containing organic groups per molecule, in an amount that the mercapto groups in component (A5) is 0.2 to 3 moles per 1 mole of the alkenyl groups in component (A4).

### Composition (M4):

(A1) an organopolysiloxane having at least one of an acryl group-containing organic group and/or a methacryl group-containing organic group per molecule;
(A2) an organopolysiloxane having at least one alkenyl group having 2 to 12 carbon atoms per molecule and free of a mercapto group-containing organic group; and
(A3) an organocompound having at least one mercapto group-containing organic group per molecule, in an amount that the mercapto groups in component (A3) is 0.1 to 3 moles per 1 mole of the sum of the acryl group-containing organic groups and/or methacryl group-containing organic groups in component (A1) and the alkenyl groups in component (A2).

### Composition (M5):

(A6) an organopolysiloxane having at least one of an acryl group-containing organic group and/or a methacryl group-containing organic group per molecule, having at least one alkenyl group per molecule, and free of a mercapto group-containing organic group; and
(A3) an organocompound having at least one mercapto group-containing organic group per molecule, in an amount that the mercapto groups in component (A3) is 0 to 3 moles per 1 mole of the sum of the acryl group-containing organic groups and/or methacryl group-containing organic groups and the alkenyl groups in component (A6).

### Composition (M6):

(A7) an organopolysiloxane having at least two alkenyl groups having 2 to 12 carbon atoms per molecule, and having at least two mercapto group-containing organic groups per molecule.

### Composition (M7):

(A8) an organopolysiloxane having at least one of an acryl group-containing organic group and/or a methacryl group-containing organic group per molecule, having at least one alkenyl group having 2 to 12 carbon atoms per molecule, and having at least one mercapto group-containing organic group per molecule.

In the formulae, examples of the acryl group-containing organic groups, methacryl groups-containing organic groups, alkenyl groups, and mercapto group-containing organic groups are as described above.

And, examples of groups bonded to the silicon atom other than the acryl group-containing organic groups, methacryl groups-containing organic groups, alkenyl groups, and mercapto group-containing organic groups in each component are as described above.

Examples of component (A1) include organopolysiloxanes represented by the following formulae. In the formulae, “Me” represents a methyl group, “Ph” represents a phenyl group, “Ac” represents an acryloxypropyl group, “MA” represents a methacryloxypropyl group; “p”, “q”, “r” and “s” are respectively positive numbers, and the total of “p”, “q”, “r” and “s” in a molecule is 1; and “u” is an integer of from 3 to 20.

(Me₂AcSiO_{1/2})₂

(Me₂MASiO_{1/2})₂

(MeAcSiO_{2/2})ᵤ

(MeMASiO_{2/2})ᵤ

(MeAcSiO_{2/2})ₚ(Me₂SiO_{2/2})_{q}

(MeMASiO_{2/2})ₚ(Me₂SiO_{2/2})_{q}

(MeAcSiO_{2/2})ₚ(Ph₂SiO_{2/2})_{q}

(MeMASiO_{2/2})ₚ(Ph₂SiO_{2/2})_{q}

(MeAcSiO_{2/2})ₚ(Me₂SiO_{2/2})_{q}(Ph₂SiO_{2/2})ᵣ

(MeMASiO_{2/2})ₚ(Me₂SiO_{2/2})_{q}(Ph₂SiO_{2/2})ᵣ

(Me₃SiO_{1/2})ₚ(Me₂SiO_{2/2})_{q}(MeAcSiO_{2/2})ᵣ

(Me₃SiO_{1/2})ₚ(Me₂SiO_{2/2})_{q}(MeMASiO_{2/2})ᵣ

(Me₃SiO_{1/2})ₚ(Ph₂SiO_{2/2})_{q}(MeAcSiO_{2/2})ᵣ

(Me₃SiO_{1/2})ₚ(Ph₂SiO_{2/2})_{q}(MeMASiO_{2/2})ᵣ

(Me₃SiO_{1/2})ₚ(Me₂SiO_{2/2})_{q}(Ph₂SiO_{2/2})ᵣ(MeAcSiO_{2/2})ₛ

(Me₃SiO_{1/2})ₚ(Me₂SiO_{2/2})_{q}(Ph₂SiO_{2/2})ᵣ(MeMASiO_{2/2})ₛ

(Me₂AcSiO_{1/2})ₚ(Me₂SiO_{2/2})_{q}

(Me₂MASiO_{1/2})ₚ(Me₂SiO_{2/2})_{q}

(Me₂AcSiO_{1/2})ₚ(Ph₂SiO_{2/2})_{q}

(Me₂MASiO_{1/2})ₚ(Ph₂SiO_{2/2})_{q}

(Me₂AcSiO_{1/2})ₚ(Me₂SiO_{2/2})_{q}(Ph₂SiO_{2/2})ᵣ

(Me₂MASiO_{1/2})ₚ(Me₂SiO_{2/2})_{q}(Ph₂SiO_{2/2})ᵣ

(Me₂AcSiO_{1/2})ₚ(Me₂SiO_{2/2})_{q}(MeAcSiO_{2/2})ᵣ

(Me₂MASiO_{1/2})ₚ(Me₂SiO_{2/2})_{q}(MeMASiO_{2/2})ᵣ

(Me₂AcSiO_{1/2})ₚ(Ph₂SiO_{2/2})_{q}(MeAcSiO_{2/2})ᵣ

(Me₂MASiO_{1/2})ₚ(Ph₂SiO_{2/2})_{q}(MeMASiO_{2/2})ᵣ

(Me₂AcSiO_{1/2})ₚ(Me₂SiO_{2/2})_{q}(Ph₂SiO_{2/2})ᵣ(MeAcSiO_{2/2})ₛ

(Me₂MASiO_{1/2})ₚ(Me₂SiO_{2/2})_{q}(Ph₂SiO_{2/2})ᵣ(MeMASiO_{2/2})ₛ

(Me₂AcSiO_{1/2})ₚ(Me₂SiO_{2/2})_{q}(MeSiO_{3/2})ᵣ

(Me₂MASiO_{1/2})ₚ(Me₂SiO_{2/2})_{q}(MeSiO_{3/2})ᵣ

(Me₂ACSiO_{1/2})ₚ(Me₂SiO_{2/2})_{q}(PhSiO_{3/2})ᵣ

(Me₂MASiO_{1/2})ₚ(Me₂SiO_{2/2})_{q}(PhSiO_{3/2})ᵣ

(Me₂ACSiO_{1/2})ₚ(Ph₂SiO_{2/2})_{q}(MeSiO_{3/2})ᵣ

(Me₂MASiO_{1/2})ₚ(Ph₂SiO_{2/2})_{q}(MeSiO_{3/2})ᵣ

(Me₃SiO_{1/2})ₚ(Me₂SiO_{2/2})_{q}(AcSiO_{3/2})ᵣ

(Me₃SiO_{1/2})ₚ(Me₂SiO_{2/2})_{q}(MASiO_{3/2})ᵣ

(Me₃SiO_{1/2})ₚ(MePhSiO_{2/2})_{q}(MeAcSiO_{2/2})ᵣ

(Me₃SiO_{1/2})ₚ(MePhSiO_{2/2})_{q}(MeMASiO_{2/2})ᵣ

(Me₃SiO_{1/2})ₚ(Ph₂SiO_{2/2})_{q}(AcSiO_{3/2})ᵣ

(Me₃SiO_{1/2})ₚ(Ph₂SiO_{2/2})_{q}(MASiO_{3/2})ᵣ

(Me₃SiO_{1/2})ₚ(Me₂SiO_{2/2})_{q}(Ph₂SiO_{2/2})ᵣ(AcSiO_{3/2})ₛ

(Me₃SiO_{1/2})ₚ(Me₂SiO_{2/2})_{q}(Ph₂SiO_{2/2})ᵣ(MASiO_{3/2})ₛ

(Me₂AcSiO_{1/2})ₚ(MePhSiO_{2/2})_{q}

(Me₂MASiO_{1/2})ₚ(MePhSiO_{2/2})_{q}

(Me₂AcSiO_{1/2})ₚ(MePhSiO_{2/2})_{q}(MeSiO_{3/2})ᵣ

(Me₂MASiO_{1/2})ₚ(MePhSiO_{2/2})_{q}(MeSiO_{3/2})ᵣ

(Me₂AcSiO_{1/2})ₚ(MePhSiO_{2/2})_{q}(PhSiO_{3/2})ᵣ

(Me₂MASiO_{1/2})ₚ(MePhSiO_{2/2})_{q}(PhSiO_{3/2})ᵣ

(Me₃SiO_{1/2})ₚ(MePhSiO_{2/2})_{q}(AcSiO_{3/2})ᵣ

(Me₃SiO_{1/2})ₚ(MePhSiO_{2/2})_{q}(MASiO_{3/2})ᵣ

Examples of component (A2) include organopolysiloxanes represented by the following formulae. In the formulae, “Me”, “Ph”, “p”, “q”, “r”, “s” and “u” are as described above; and “Vi” represents a vinyl group.

(Me₂ViSiO_{1/2})₂

(MeViSiO_{2/2})ᵤ

(MeViSiO_{2/2})ₚ(Me₂SiO_{2/2})_{q}

(Me₃SiO_{1/2})ₚ(Me₂SiO_{2/2})_{q}(MeViSiO_{2/2})ᵣ

(Me₃SiO_{1/2})ₚ(MePhSiO_{2/2})_{q}(MeViSiO_{2/2})ᵣ

(Me₃SiO_{1/2})ₚ(Ph₂SiO_{2/2})_{q}(MeViSiO_{2/2})ᵣ

(Me₃SiO_{1/2})ₚ(Me₂SiO_{2/2})_{q}(Ph₂SiO_{2/2})ᵣ(MeViSiO_{2/2})ₛ

(Me₃SiO_{1/2})ₚ(MeViSiO_{2/2})_{q}

(Me₂ViSiO_{1/2})ₚ(Me₂SiO_{2/2})_{q}

(Me₂ViSiO_{1/2})ₚ(Ph₂SiO_{2/2})_{q}

(Me₂ViSiO_{1/2})ₚ(MePhSiO_{2/2})_{q}

(Me₂ViSiO_{1/2})ₚ(Me₂SiO_{2/2})_{q}(Ph₂SiO_{2/2})ᵣ

(Me₂ViSiO_{1/2})ₚ(Me₂SiO_{2/2})_{q}(MeViSiO_{2/2})ᵣ

(Me₂ViSiO_{1/2})ₚ(MePhSiO_{2/2})_{q}(MeViSiO_{2/2})ᵣ

(Me₂ViSiO_{1/2})ₚ(Ph₂SiO_{2/2})_{q}(MeViSiO_{2/2})ᵣ

(Me₂ViSiO_{1/2})ₚ(MeSiO_{3/2})_{q}

(Me₂ViSiO_{1/2})ₚ(PhSiO_{3/2})_{q}

(Me₂ViSiO_{1/2})ₚ(Me₂SiO_{2/2})_{q}(MeSiO_{3/2})ᵣ

(Me₂ViSiO_{1/2})ₚ(Me₂SiO_{2/2})_{q}(PhSiO_{3/2})ᵣ

(Me₂ViSiO_{1/2})ₚ(Ph₂SiO_{2/2})_{q}(MeSiO_{3/2})ᵣ

(Me₂ViSiO_{1/2})ₚ(Ph₂SiO_{2/2})_{q}(PhSiO_{3/2})ᵣ

(Me₂ViSiO_{1/2})ₚ(Me₂SiO_{2/2})_{q}(Ph₂SiO_{2/2})ᵣ(MeSiO_{3/2})ₛ

(Me₂ViSiO_{1/2})ₚ(Me₂SiO_{2/2})_{q}(Ph₂SiO_{2/2})ᵣ(PhSiO_{3/2})ₛ

(Me₂ViSiO_{1/2})ₚ(MePhSiO_{2/2})_{q}(MeSiO_{3/2})ᵣ

(Me₂ViSiO_{1/2})ₚ(MePhSiO_{2/2})_{q}(PhSiO_{3/2})ᵣ

(Me₃SiO_{1/2})ₚ(Me₂ViSiO_{1/2})_{q}(Me₂SiO_{2/2})ᵣ(SiO_{4/2})ₛ

(Me₂ViSiO_{1/2})ₚ(Me₂SiO_{2/2})_{q}(SiO_{4/2})ᵣ

(Me₃SiO_{1/2})ₚ(Me₂ViSiO_{1/2})_{q}(SiO_{4/2})ᵣ

(Me₃SiO_{1/2})ₚ(MeViSiO_{2/2})_{q}(SiO_{4/2})ᵣ

(Me₂ViSiO_{1/2})ₚ(SiO_{4/2})_{q}

(Me₃SiO_{1/2})ₚ(Me₂SiO_{2/2})_{q}(ViSiO_{3/2})ᵣ

(Me₃SiO_{1/2})ₚ(MePhSiO_{2/2})_{q}(ViSiO_{3/2})ᵣ

(Me₃SiO_{1/2})ₚ(Ph₂SiO_{2/2})_{q}(ViSiO_{3/2})ᵣ

(Me₃SiO_{1/2})ₚ(ViSiO_{3/2})_{q}

Examples of component (A3) include organopolysiloxanes represented by the following formulae. In the formulae, “Me”, “Ph”, “p”, “q”, “r”, “s” and “u” are as described above; and “MP” represents a mercaptopropyl group.

(MeMPSiO_{2/2})ᵤ

(Me₂SiO_{2/2})ₚ(MeMPSiO_{2/2})_{q}

(Me₃SiO_{1/2})ₚ(Me₂SiO_{2/2})_{q}(MeMPSiO_{2/2})ᵣ

(Me₃SiO_{1/2})ₚ(Ph₂SiO_{2/2})_{q}(MeMPSiO_{2/2})ᵣ

(Me₃SiO_{1/2})ₚ(Me₂SiO_{2/2})_{q}(Ph₂SiO_{2/2})ᵣ(MeMPSiO_{2/2})ₛ

(Me₃SiO_{1/2})ₚ(MeMPSiO_{2/2})_{q}

(Me₃SiO_{1/2})ₚ(MePhSiO_{2/2})_{q}(MeMPSiO_{2/2})ᵣ

(Me₃SiO_{1/2})ₚ(MPSiO_{3/2})_{q}

(Me₃SiO_{1/2})ₚ(Me₂SiO_{2/2})_{q}(MPSiO_{3/2})ᵣ

Examples of component (A4) include organopolysiloxanes for component (A2) as described above. However, component (A4) has at least two alkenyl groups having 2 to 12 carbon atoms per molecule.

Examples of component (A5) include organopolysiloxanes for component (A3) as described above. However, component (A5) has at least two mercapto group-containing organic groups per molecule.

Examples of component (A6) include organopolysiloxanes represented by the following formulae. In the formulae, “Me”, “Ph”, “Ac”, “MA”, “Vi”, “p”, “q”, “r” and “s” are as described above.

(MeAcSiO_{2/2})ₚ(MeViSiO_{2/2})_{q}

(MeMASiO_{2/2})ₚ(MeViSiO_{2/2})_{q}

(Me₃SiO_{1/2})ₚ(Me₂SiO_{2/2})_{q}(MeViSiO_{2/2})ᵣ(MeAcSiO_{2/2})ₛ

(Me₃SiO_{1/2})ₚ(Me₂SiO_{2/2})_{q}(MeViSiO_{2/2})ᵣ(MeMASiO_{2/2})ₛ

(Me₃SiO_{1/2})ₚ(Ph₂SiO_{2/2})_{q}(MeViSiO_{2/2})ᵣ(MeAcSiO_{2/2})ₛ

(Me₃SiO_{1/2})ₚ(Ph₂SiO_{2/2})_{q}(MeViSiO_{2/2})ᵣ(MeMASiO_{2/2})ₛ

(Me₃SiO_{1/2})ₚ(MeViSiO_{2/2})_{q}(MeAcSiO_{2/2})ᵣ

(Me₃SiO_{1/2})ₚ(MeViSiO_{2/2})_{q}(MeMASiO_{2/2})ᵣ

(Me₂ViSiO_{1/2})ₚ(MeAcSiO_{2/2})_{q}

(Me₂ViSiO_{1/2})ₚ(MeMASiO_{2/2})_{q}

(Me₂ViSiO_{1/2})ₚ(Me₂SiO_{2/2})_{q}(MeAcSiO_{2/2})ᵣ

(Me₂ViSiO_{1/2})ₚ(Me₂SiO_{2/2})_{q}(MeMASiO_{2/2})ᵣ

(Me₂ViSiO_{1/2})ₚ(Ph₂SiO_{2/2})_{q}(MeAcSiO_{2/2})ᵣ

(Me₂ViSiO_{1/2})ₚ(Ph₂SiO_{2/2})_{q}(MeMASiO_{2/2})ᵣ

(Me₂ViSiO_{1/2})ₚ(Me₂SiO_{2/2})_{q}(Ph₂SiO_{2/2})ᵣ(MeAcSiO_{2/2})ₛ

(Me₂ViSiO_{1/2})ₚ(Me₂SiO_{2/2})_{q}(Ph₂SiO_{2/2})ᵣ(MeMASiO_{2/2})ₛ

(Me₂AcSiO_{1/2})ₚ(Me₂ViSiO_{1/2})_{q}(MeSiO_{3/2})ᵣ

(Me₂MASiO_{1/2})ₚ(Me₂ViSiO_{1/2})_{q}(MeSiO_{3/2})ᵣ

(Me₂AcSiO_{1/2})ₚ(Me₂ViSiO_{1/2})_{q}(PhSiO_{3/2})ᵣ

(Me₂MASiO_{1/2})ₚ(Me₂ViSiO_{1/2})_{q}(PhSiO_{3/2})ᵣ

(Me₂AcSiO_{1/2})ₚ(Me₃SiO_{1/2})_{q}(ViSiO_{3/2})ᵣ

(Me₂MASiO_{1/2})ₚ(Me₃SiO_{1/2})_{q}(ViSiO_{3/2})ᵣ

(Me₂AcSiO_{1/2})ₚ(Me₂SiO_{2/2})_{q}(ViSiO_{3/2})ᵣ

(Me₂MASiO_{1/2})ₚ(Me₂SiO_{2/2})_{q}(ViSiO_{3/2})ᵣ

(Me₂AcSiO_{1/2})ₚ(Ph₂SiO_{2/2})_{q}(ViSiO_{3/2})ᵣ

(Me₂MASiO_{1/2})ₚ(Ph₂SiO_{2/2})_{q}(ViSiO_{3/2})ᵣ

(Me₂AcSiO_{1/2})ₚ(MeViSiO_{2/2})_{q}(Me₂SiO_{2/2})ᵣ

(Me₂MASiO_{1/2})ₚ(MeViSiO_{2/2})_{q}(Me₂SiO_{2/2})ᵣ

(Me₂AcSiO_{1/2})ₚ(MeViSiO_{2/2})_{q}(Me₂SiO_{2/2})ᵣ(MeAcSiO_{2/2})ₛ

(Me₂MASiO_{1/2})ₚ(MeViSiO_{2/2})_{q}(Me₂SiO_{2/2})ᵣ(MeMASiO_{2/2})ₛ

(Me₂AcSiO_{1/2})ₚ(Me₂ViSiO_{1/2})_{q}(Me₂SiO_{2/2})ᵣ(MeSiO_{3/2})ₛ

(Me₂MASiO_{1/2})ₚ(Me₂ViSiO_{1/2})_{q}(Me₂SiO_{2/2})ᵣ(MeSiO_{3/2})ₛ

(Me₂AcSiO_{1/2})ₚ(Me₂ViSiO_{1/2})_{q}(Ph₂SiO_{2/2})ᵣ(MeSiO_{3/2})ₛ

(Me₂MASiO_{1/2})ₚ(Me₂ViSiO_{1/2})_{q}(Ph₂SiO_{2/2})ᵣ(MeSiO_{3/2})ₛ

(Me₂AcSiO_{1/2})ₚ(Me₂ViSiO_{1/2})_{q}(Me₂SiO_{2/2})ᵣ(PhSiO_{3/2})ₛ

(Me₂MASiO_{1/2})ₚ(Me₂ViSiO_{1/2})_{q}(Me₂SiO_{2/2})ᵣ(PhSiO_{3/2})ₛ

(Me₂AcSiO_{1/2})ₚ(MeViSiO_{2/2})_{q}(MeSiO_{3/2})ᵣ

(Me₂MASiO_{1/2})ₚ(MeViSiO_{2/2})_{q}(MeSiO_{3/2})ᵣ

(Me₂AcSiO_{1/2})ₚ(MeViSiO_{2/2})_{q}(PhSiO_{3/2})ᵣ

(Me₂MASiO_{1/2})ₚ(MeViSiO_{2/2})_{q}(PhSiO_{3/2})ᵣ

(Me₂AcSiO_{1/2})ₚ(MeViSiO_{2/2})_{q}(Me₂SiO_{2/2})ᵣ(MeSiO_{3/2})ₛ

(Me₂MASiO_{1/2})ₚ(MeViSiO_{2/2})_{q}(Me₂SiO_{2/2})ᵣ(MeSiO_{3/2})ₛ

(Me₂AcSiO_{1/2})ₚ(MeViSiO_{2/2})_{q}(Me₂SiO_{2/2})ᵣ(PhSiO_{3/2})ₛ

(Me₂MASiO_{1/2})ₚ(MeViSiO_{2/2})_{q}(Me₂SiO_{2/2})ᵣ(PhSiO_{3/2})ₛ

(Me₃SiO_{1/2})ₚ(Me₂ViSiO_{1/2})_{q}(Me₂SiO_{2/2})ᵣ(ACSiO_{3/2})ₛ

(Me₃SiO_{1/2})ₚ(Me₂ViSiO_{1/2})_{q}(Me₂SiO_{2/2})ᵣ(MASiO_{3/2})ₛ

(Me₂ViSiO_{1/2})ₚ(AcSiO_{3/2})_{q}

(Me₂ViSiO_{1/2})ₚ(MASiO_{3/2})_{q}

(Me₂ViSiO_{1/2})ₚ(Me₃SiO_{1/2})_{q}(AcSiO_{3/2})ᵣ

(Me₂ViSiO_{1/2})ₚ(Me₃SiO_{1/2})_{q}(MASiO_{3/2})ᵣ

(Me₂ViSiO_{1/2})ₚ(Me₂SiO_{2/2})_{q}(AcSiO_{3/2})ᵣ

(Me₂ViSiO_{1/2})ₚ(Me₂SiO_{2/2})_{q}(MASiO_{3/2})ᵣ

(Me₂ViSiO_{1/2})ₚ(MePhSiO_{2/2})_{q}(MeAcSiO_{2/2})ᵣ

(Me₂ViSiO_{1/2})ₚ(MePhSiO_{2/2})_{q}(MeMASiO_{2/2})ᵣ

(Me₂AcSiO_{1/2})ₚ(MePhSiO_{2/2})_{q}(MeViSiO_{2/2})ᵣ

(Me₂MASiO_{1/2})ₚ(MePhSiO_{2/2})_{q}(MeViSiO_{2/2})ᵣ

(Me₂AcSiO_{1/2})ₚ(MePhSiO_{2/2})_{q}(MeViSiO_{2/2})ᵣ(MeSiO_{3/2})ₛ

(Me₂MASiO_{1/2})ₚ(MePhSiO_{2/2})_{q}(MeViSiO_{2/2})ᵣ(MeSiO_{3/2})ₛ

(Me₂AcSiO_{1/2})ₚ(MePhSiO_{2/2})_{q}(MeViSiO_{2/2})ᵣ(PhSiO_{3/2})ₛ

(Me₂MASiO_{1/2})ₚ(MePhSiO_{2/2})_{q}(MeViSiO_{2/2})ᵣ(PhSiO_{3/2})ₛ

(Me₂AcSiO_{1/2})ₚ(MePhSiO_{2/2})_{q}(ViSiO_{3/2})ᵣ

(Me₂MASiO_{1/2})ₚ(MePhSiO_{2/2})_{q}(ViSiO_{2/2})ᵣ

(Me₃SiO_{1/2})ₚ(MePhSiO_{2/2})_{q}(AcSiO_{3/2})ᵣ(ViSiO_{3/2})ₛ

(Me₃SiO_{1/2})ₚ(MePhSiO_{2/2})_{q}(MASiO_{3/2})ᵣ(ViSiO_{3/2})ₛ

(Me₃SiO_{1/2})ₚ(Me₂AcSiO_{1/2})_{q}(ViSiO_{3/2})ᵣ

(Me₃SiO_{1/2})ₚ(Me₂MASiO_{1/2})_{q}(ViSiO_{3/2})ᵣ

(Me₃SiO_{1/2})ₚ(MeAcSiO_{2/2})_{q}(ViSiO_{3/2})ᵣ

(Me₃SiO_{1/2})ₚ(MeMASiO_{2/2})_{q}(ViSiO_{3/2})ᵣ

Examples of component (A7) include organopolysiloxane represented by the following formulae. In the formulae, “Me”, “Ph”, “Vi”, “MP”, “p”, “q”, “r” and “s” are as described above.

(MeViSiO_{2/2})ₚ(MeMPSiO_{2/2})_{q}

(Me₂ViSiO_{1/2})ₚ(MeMPSiO_{2/2})_{q}

(Me₂ViSiO_{1/2})ₚ(Me₂SiO_{2/2})_{q}(MeMPSiO_{2/2})ᵣ

(Me₂ViSiO_{1/2})ₚ(Ph₂SiO_{2/2})_{q}(MeMPSiO_{2/2})ᵣ

(Me₂ViSiO_{1/2})ₚ(MePhSiO_{2/2})_{q}(MeMPSiO_{2/2})ᵣ

(Me₃SiO_{1/2})ₚ(MeViSiO_{2/2})_{q}(MeMPSiO_{2/2})ᵣ

(Me₃SiO_{1/2})ₚ(Me₂SiO_{2/2})_{q}(MeViSiO_{2/2})ᵣ(MeMPSiO_{2/2})ₛ

(Me₃SiO_{1/2})ₚ(MePhSiO_{2/2})_{q}(MeViSiO_{2/2})ᵣ(MeMPSiO_{2/2})ₛ

(Me₃SiO_{1/2})ₚ(Ph₂SiO_{2/2})_{q}(MeViSiO_{2/2})ᵣ(MeMPSiO_{2/2})ₛ

(Me₃SiO_{1/2})ₚ(MeViSiO_{2/2})_{q}(MeMPSiO_{2/2})ᵣ(MeSiO_{3/2})ₛ

(Me₃SiO_{1/2})ₚ(MeViSiO_{2/2})_{q}(MeMPSiO_{2/2})ᵣ(PhSiO_{3/2})ₛ

(Me₂ViSiO_{1/2})ₚ(Me₂SiO_{2/2})_{q}(MeMPSiO_{2/2})ᵣ(MeSiO_{3/2})ₛ

(Me₂ViSiO_{1/2})ₚ(Me₂SiO_{2/2})_{q}(MeMPSiO_{2/2})ᵣ(PhSiO_{3/2})ₛ

(Me₂ViSiO_{1/2})ₚ(Me₂SiO_{2/2})_{q}(MPSiO_{3/2})ᵣ

(Me₂ViSiO_{1/2})ₚ(MePhSiO_{2/2})_{q}(MPSiO_{3/2})ᵣ

(Me₂ViSiO_{1/2})ₚ(Ph₂SiO_{2/2})_{q}(MPSiO_{3/2})ᵣ

(Me₃SiO_{1/2})ₚ(MeViSiO_{2/2})_{q}(MPSiO_{3/2})ᵣ

(Me₂ViSiO_{1/2})ₚ(MPSiO_{3/2})_{q}

(Me₃SiO_{1/2})ₚ(Me₂ViSiO_{1/2})_{q}(MPSiO_{3/2})ᵣ

(Me₃SiO_{1/2})ₚ(ViSiO_{3/2})_{q}(MPSiO_{3/2})ᵣ

(Me₃SiO_{1/2})ₚ(Me₂SiO_{2/2})_{q}(ViSiO_{3/2})ᵣ(MPSiO_{3/2})ₛ

(Me₃SiO_{1/2})ₚ(Me₂SiO_{2/2})_{q}(MeViSiO_{2/2})ᵣ(MPSiO_{3/2})ₛ

(Me₃SiO_{1/2})ₚ(MeMPSiO_{2/2})_{q}(ViSiO_{3/2})ᵣ

(Me₃SiO_{1/2})ₚ(Me₂SiO_{2/2})_{q}(MeMPSiO_{2/2})ᵣ(ViSiO_{3/2})ₛ

Examples of component (A8) include organopolysiloxanes represented by the following formulae. In the formulae, “Me”, “Ph”, “Ac”, “MA”, “Vi”, “MP”, “p”, “q”, “r” and “s” are as described above.

(MeAcSiO_{2/2})ₚ(MeViSiO_{2/2})_{q}(MeMPSiO_{2/2})ᵣ

(MeMASiO_{2/2})ₚ(MeViSiO_{2/2})_{q}(MeMPSiO_{2/2})ᵣ

(Me₃SiO_{1/2})ₚ(MeViSiO_{2/2})_{q}(MeMPSiO_{2/2})ᵣ(MeAcSiO_{2/2})ₛ

(Me₃SiO_{1/2})ₚ(MeViSiO_{2/2})_{q}(MeMPSiO_{2/2})ᵣ(MeMASiO_{2/2})ₛ

(Me₃SiO_{1/2})ₚ(Me₂ViSiO_{1/2})_{q}(MeMPSiO_{2/2})ᵣ(AcSiO_{3/2})ₛ

(Me₃SiO_{1/2})ₚ(Me₂ViSiO_{1/2})_{q}(MeMPSiO_{2/2})ᵣ(MASiO_{3/2})ₛ

(Me₃SiO_{1/2})ₚ(Me₂ViSiO_{1/2})_{q}(MPSiO_{3/2})ᵣ(MeACSiO_{2/2})ₛ

(Me₃SiO_{1/2})ₚ(Me₂ViSiO_{1/2})_{q}(MPSiO_{3/2})ᵣ(MeMASiO_{2/2})ₛ

(Me₃SiO_{1/2})ₚ(Me₂ViSiO_{1/2})_{q}(MPSiO_{3/2})ᵣ(AcSiO_{3/2})ₛ

(Me₃SiO_{1/2})ₚ(Me₂ViSiO_{1/2})_{q}(MPSiO_{3/2})ᵣ(MASiO_{3/2})ₛ

(Me₃SiO_{1/2})ₚ(MeViSiO_{2/2})_{q}(MeMPSiO_{2/2})ᵣ(AcSiO_{3/2})ₛ

(Me₃SiO_{1/2})ₚ(MeViSiO_{2/2})_{q}(MeMPSiO_{2/2})ᵣ(MASiO_{3/2})ₛ

(Me₃SiO_{1/2})ₚ(MeViSiO_{2/2})_{q}(MPSiO_{3/2})ᵣ(MeAcSiO_{2/2})ₛ

(Me₃SiO_{1/2})ₚ(MeViSiO_{2/2})_{q}(MPSiO_{3/2})ᵣ(MeMASiO_{2/2})ₛ

(Me₃SiO_{1/2})ₚ(MeViSiO_{2/2})_{q}(MPSiO_{3/2})ᵣ(AcSiO_{3/2})ₛ

(Me₃SiO_{1/2})ₚ(MeViSiO_{2/2})_{q}(MPSiO_{3/2})ᵣ(MASiO_{3/2})ₛ

(Me₂ViSiO_{1/2})ₚ(Me₂SiO_{2/2})_{q}(MeMPSiO_{2/2})ᵣ(MeAcSiO_{2/2})ₛ

(Me₂ViSiO_{1/2})ₚ(Me₂SiO_{2/2})_{q}(MeMPSiO_{2/2})ᵣ(MeMASiO_{2/2})ₛ

(Me₂ViSiO_{1/2})ₚ(Me₂SiO_{2/2})_{q}(MeMPSiO_{2/2})ᵣ(AcSiO_{3/2})ₛ

(Me₂ViSiO_{1/2})ₚ(Me₂SiO_{2/2})_{q}(MeMPSiO_{2/2})ᵣ(MASiO_{3/2})ₛ

(Me₂ViSiO_{1/2})ₚ(Me₂SiO_{2/2})_{q}(MPSiO_{3/2})ᵣ(MeAcSiO_{2/2})ₛ

(Me₂ViSiO_{1/2})ₚ(Me₂SiO_{2/2})_{q}(MPSiO_{3/2})ᵣ(MeMASiO_{2/2})ₛ

(Me₂ViSiO_{1/2})ₚ(Me₂SiO_{2/2})_{q}(MPSiO_{3/2})ᵣ(AcSiO_{3/2})ₛ

(Me₂ViSiO_{1/2})ₚ(Me₂SiO_{2/2})_{q}(MPSiO_{3/2})ᵣ(MASiO_{3/2})ₛ

(Me₂ViSiO_{1/2})ₚ(MeMPSiO_{2/2})_{q}(MeAcSiO_{2/2})ᵣ

(Me₂ViSiO_{1/2})ₚ(MeMPSiO_{2/2})_{q}(MeMASiO_{2/2})ᵣ

(Me₂ViSiO_{1/2})ₚ(MeMPSiO_{2/2})_{q}(AcSiO_{3/2})ᵣ

(Me₂ViSiO_{1/2})ₚ(MeMPSiO_{2/2})_{q}(MASiO_{3/2})ᵣ

(Me₂ViSiO_{1/2})ₚ(MPSiO_{3/2})_{q}(MeAcSiO_{2/2})ᵣ

(Me₂ViSiO_{1/2})ₚ(MPSiO_{3/2})_{q}(MeMASiO_{2/2})ᵣ

(Me₂ViSiO_{1/2})ₚ(MPSiO_{3/2})_{q}(AcSiO_{3/2})ᵣ

(Me₂ViSiO_{1/2})ₚ(MPSiO_{3/2})_{q}(MASiO_{3/2})ᵣ

(Me₂ViSiO_{1/2})ₚ(Ph₂SiO_{2/2})_{q}(MeMPSiO_{2/2})ᵣ(MeAcSiO_{2/2})ₛ

(Me₂ViSiO_{1/2})ₚ(Ph₂SiO_{2/2})_{q}(MeMPSiO_{2/2})ᵣ(MeMASiO_{2/2})ₛ

(Me₂ViSiO_{1/2})ₚ(Ph₂SiO_{2/2})_{q}(MeMPSiO_{2/2})ᵣ(AcSiO_{3/2})ₛ

(Me₂ViSiO_{1/2})ₚ(Ph₂SiO_{2/2})_{q}(MeMPSiO_{2/2})ᵣ(MASiO_{3/2})ₛ

(Me₂ViSiO_{1/2})ₚ(Ph₂SiO_{2/2})_{q}(MPSiO_{3/2})ᵣ(MeAcSiO_{2/2})ₛ

(Me₂ViSiO_{1/2})ₚ(Ph₂SiO_{2/2})_{q}(MPSiO_{3/2})ᵣ(MeMASiO_{2/2})ₛ

(Me₂ViSiO_{1/2})ₚ(Ph₂SiO_{2/2})_{q}(MPSiO_{3/2})ᵣ(AcSiO_{3/2})ₛ

(Me₂ViSiO_{1/2})ₚ(Ph₂SiO_{2/2})_{q}(MPSiO_{3/2})ᵣ(MASiO_{3/2})ₛ

(Me₂ViSiO_{1/2})ₚ(MePhSiO_{2/2})_{q}(MeMPSiO_{2/2})ᵣ(MeAcSiO_{2/2})ₛ

(Me₂ViSiO_{1/2})ₚ(MePhSiO_{2/2})_{q}(MeMPSiO_{2/2})ᵣ(MeMASiO_{2/2})ₛ

(Me₂ViSiO_{1/2})ₚ(MePhSiO_{2/2})_{q}(MeMPSiO_{2/2})ᵣ(AcSiO_{3/2})ₛ

(Me₂ViSiO_{1/2})ₚ(MePhSiO_{2/2})_{q}(MeMPSiO_{2/2})ᵣ(MASiO_{3/2})ₛ

(Me₂ViSiO_{1/2})ₚ(MePhSiO_{2/2})_{q}(MPSiO_{3/2})ᵣ(MeAcSiO_{2/2})ₛ

(Me₂ViSiO_{1/2})ₚ(MePhSiO_{2/2})_{q}(MPSiO_{3/2})ᵣ(MeMASiO_{2/2})ₛ

(Me₂ViSiO_{1/2})ₚ(MePhSiO_{2/2})_{q}(MPSiO_{3/2})ᵣ(AcSiO_{3/2})ₛ

(Me₂ViSiO_{1/2})ₚ(MePhSiO_{2/2})_{q}(MPSiO_{3/2})ᵣ(MASiO_{3/2})ₛ

(Me₂ViSiO_{1/2})ₚ(MPSiO_{3/2})_{q}(Me₂AcSiO_{1/2})ᵣ

(Me₂ViSiO_{1/2})ₚ(MPSiO_{3/2})_{q}(Me₂MASiO_{1/2})ᵣ

(Me₂ViSiO_{1/2})ₚ(Me₂SiO_{2/2})_{q}(MPSiO_{3/2})ᵣ(Me₂AcSiO_{1/2})ₛ

(Me₂ViSiO_{1/2})ₚ(Me₂SiO_{2/2})_{q}(MPSiO_{3/2})ᵣ(Me₂MASiO_{1/2})ₛ

(Me₂ViSiO_{1/2})ₚ(Ph₂SiO_{2/2})_{q}(MPSiO_{3/2})ᵣ(Me₂AcSiO_{1/2})ₛ

(Me₂ViSiO_{1/2})ₚ(Ph₂SiO_{2/2})_{q}(MPSiO_{3/2})ᵣ(Me₂MASiO_{1/2})ₛ

(Me₂ViSiO_{1/2})ₚ(MePhSiO_{2/2})_{q}(MPSiO_{3/2})ᵣ(Me₂AcSiO_{1/2})ₛ

(Me₂ViSiO_{1/2})ₚ(MePhSiO_{2/2})_{q}(MPSiO_{3/2})ᵣ(Me₂MASiO_{1/2})ₛ

(Me₂ViSiO_{1/2})ₚ(MeSiO_{3/2})_{q}(MPSiO_{3/2})ᵣ(Me₂AcSiO_{1/2})ₛ

(Me₂ViSiO_{1/2})ₚ(MeSiO_{3/2})_{q}(MPSiO_{3/2})ᵣ(Me₂MASiO_{1/2})ₛ

(Me₂ViSiO_{1/2})ₚ(PhSiO_{3/2})_{q}(MPSiO_{3/2})ᵣ(Me₂AcSiO_{1/2})ₛ

(Me₂ViSiO_{1/2})ₚ(PhSiO_{3/2})_{q}(MPSiO_{3/2})ᵣ(Me₂MASiO_{1/2})ₛ

(Me₂ViSiO_{1/2})ₚ(MeSiO_{3/2})_{q}(MeMPSiO_{2/2})ᵣ(Me₂AcSiO_{1/2})ₛ

(Me₂ViSiO_{1/2})ₚ(MeSiO_{3/2})_{q}(MeMPSiO_{2/2})ᵣ(Me₂MASiO_{1/2})ₛ

(Me₂ViSiO_{1/2})ₚ(PhSiO_{3/2})_{q}(MeMPSiO_{2/2})ᵣ(Me₂AcSiO_{1/2})ₛ

(Me₂ViSiO_{1/2})ₚ(PhSiO_{3/2})_{q}(MeMPSiO_{2/2})ᵣ(Me₂MASiO_{1/2})ₛ

(MeViSiO_{2/2})ₚ(MeMPSiO_{2/2})_{q}(Me₂AcSiO_{1/2})ᵣ

(MeViSiO_{2/2})ₚ(MeMPSiO_{2/2})_{q}(Me₂MASiO_{1/2})ᵣ

(MeViSiO_{2/2})ₚ(MPSiO_{3/2})_{q}(Me₂ACSiO_{1/2})ᵣ

(MeViSiO_{2/2})ₚ(MPSiO_{3/2})_{q}(Me₂MASiO_{1/2})ᵣ

(MeViSiO_{2/2})ₚ(MPSiO_{3/2})_{q}(MeAcSiO_{2/2})ᵣ

(MeViSiO_{2/2})ₚ(MPSiO_{3/2})_{q}(MeMASiO_{2/2})ᵣ

(MeViSiO_{2/2})ₚ(MeMPSiO_{2/2})_{q}(AcSiO_{3/2})ᵣ

(MeViSiO_{2/2})ₚ(MeMPSiO_{2/2})_{q}(MASiO_{3/2})ᵣ

(MeViSiO_{2/2})ₚ(MPSiO_{3/2})_{q}(AcSiO_{3/2})ᵣ

(MeViSiO_{2/2})ₚ(MPSiO_{3/2})_{q}(MASiO_{3/2})ᵣ

(MeViSiO_{2/2})ₚ(Me₂SiO_{2/2})_{q}(MeMPSiO_{2/2})ᵣ(Me₂AcSiO_{1/2})ₛ

(MeViSiO_{2/2})ₚ(Me₂SiO_{2/2})_{q}(MeMPSiO_{2/2})ᵣ(Me₂MASiO_{1/2})ₛ

(MeViSiO_{2/2})ₚ(Me₂SiO_{2/2})_{q}(MPSiO_{3/2})ᵣ(Me₂AcSiO_{1/2})ₛ

(MeViSiO_{2/2})ₚ(Me₂SiO_{2/2})_{q}(MPSiO_{3/2})ᵣ(Me₂MASiO_{1/2})ₛ

(MeViSiO_{2/2})ₚ(Me₂SiO_{2/2})_{q}(MPSiO_{3/2})ᵣ(MeAcSiO_{2/2})ₛ

(MeViSiO_{2/2})ₚ(Me₂SiO_{2/2})_{q}(MPSiO_{3/2})ᵣ(MeMASiO_{2/2})ₛ

(MeViSiO_{2/2})ₚ(Me₂SiO_{2/2})_{q}(MeMPSiO_{2/2})ᵣ(AcSiO_{3/2})ₛ

(MeViSiO_{2/2})ₚ(Me₂SiO_{2/2})_{q}(MeMPSiO_{2/2})ᵣ(MASiO_{3/2})ₛ

(MeViSiO_{2/2})ₚ(Me₂SiO_{2/2})_{q}(MPSiO_{3/2})ᵣ(AcSiO_{3/2})ₛ

(MeViSiO_{2/2})ₚ(Me₂SiO_{2/2})_{q}(MPSiO_{3/2})ᵣ(MASiO_{3/2})ₛ

(MeViSiO_{2/2})ₚ(Ph₂SiO_{2/2})_{q}(MeMPSiO_{2/2})ᵣ(Me₂AcSiO_{1/2})ₛ

(MeViSiO_{2/2})ₚ(Ph₂SiO_{2/2})_{q}(MeMPSiO_{2/2})ᵣ(Me₂MASiO_{1/2})ₛ

(MeViSiO_{2/2})ₚ(Ph₂SiO_{2/2})_{q}(MPSiO_{3/2})ᵣ(Me₂AcSiO_{1/2})ₛ

(MeViSiO_{2/2})ₚ(Ph₂SiO_{2/2})_{q}(MPSiO_{3/2})ᵣ(Me₂MASiO_{1/2})ₛ

(MeViSiO_{2/2})ₚ(Ph₂SiO_{2/2})_{q}(MPSiO_{3/2})ᵣ(MeAcSiO_{2/2})ₛ

(MeViSiO_{2/2})ₚ(Ph₂SiO_{2/2})_{q}(MPSiO_{3/2})ᵣ(MeMASiO_{2/2})ₛ

(MeViSiO_{2/2})ₚ(Ph₂SiO_{2/2})_{q}(MeMPSiO_{2/2})ᵣ(AcSiO_{3/2})ₛ

(MeViSiO_{2/2})ₚ(Ph₂SiO_{2/2})_{q}(MeMPSiO_{2/2})ᵣ(MASiO_{3/2})ₛ

(MeViSiO_{2/2})ₚ(Ph₂SiO_{2/2})_{q}(MPSiO_{3/2})ᵣ(AcSiO_{3/2})ₛ

(MeViSiO_{2/2})ₚ(Ph₂SiO_{2/2})_{q}(MPSiO_{3/2})ᵣ(MASiO_{3/2})ₛ

(MeViSiO_{2/2})ₚ(MePhSiO_{2/2})_{q}(MeMPSiO_{2/2})ᵣ(Me₂AcSiO_{1/2})ₛ

(MeViSiO_{2/2})ₚ(MePhSiO_{2/2})_{q}(MeMPSiO_{2/2})ᵣ(Me₂MASiO_{1/2})ₛ

(MeViSiO_{2/2})ₚ(MePhSiO_{2/2})_{q}(MPSiO_{3/2})ᵣ(Me₂ACSiO_{1/2})ₛ

(MeViSiO_{2/2})ₚ(MePhSiO_{2/2})_{q}(MPSiO_{3/2})ᵣ(Me₂MASiO_{1/2})ₛ

(MeViSiO_{2/2})ₚ(MePhSiO_{2/2})_{q}(MPSiO_{3/2})ᵣ(MeAcSiO_{2/2})ₛ

(MeViSiO_{2/2})ₚ(MePhSiO_{2/2})_{q}(MPSiO_{3/2})ᵣ(MeMASiO_{2/2})ₛ

(MeViSiO_{2/2})ₚ(MePhSiO_{2/2})_{q}(MeMPSiO_{2/2})ᵣ(AcSiO_{3/2})ₛ

(MeViSiO_{2/2})ₚ(MePhSiO_{2/2})_{q}(MeMPSiO_{2/2})ᵣ(MASiO_{3/2})ₛ

(MeViSiO_{2/2})ₚ(MePhSiO_{2/2})_{q}(MPSiO_{3/2})ᵣ(AcSiO_{3/2})ₛ

(MeViSiO_{2/2})ₚ(MePhSiO_{2/2})_{q}(MPSiO_{3/2})ᵣ(MASiO_{3/2})ₛ

(MeViSiO_{2/2})ₚ(MeSiO_{3/2})_{q}(MeMPSiO_{2/2})ᵣ(Me₂AcSiO_{1/2})ₛ

(MeViSiO_{2/2})ₚ(MeSiO_{3/2})_{q}(MeMPSiO_{2/2})ᵣ(Me₂MASiO_{1/2})ₛ

(MeViSiO_{2/2})ₚ(MeSiO_{3/2})_{q}(MPSiO_{3/2})ᵣ(Me₂AcSiO_{1/2})ₛ

(MeViSiO_{2/2})ₚ(MeSiO_{3/2})_{q}(MPSiO_{3/2})ᵣ(Me₂MASiO_{1/2})ₛ

(MeViSiO_{2/2})ₚ(MeSiO_{3/2})_{q}(MPSiO_{3/2})ᵣ(MeAcSiO_{2/2})ₛ

(MeViSiO_{2/2})ₚ(MeSiO_{3/2})_{q}(MPSiO_{3/2})ᵣ(MeMASiO_{2/2})ₛ

(MeViSiO_{2/2})ₚ(MeSiO_{3/2})_{q}(MeMPSiO_{2/2})ᵣ(AcSiO_{3/2})ₛ

(MeViSiO_{2/2})ₚ(MeSiO_{3/2})_{q}(MeMPSiO_{2/2})ᵣ(MASiO_{3/2})ₛ

(MeViSiO_{2/2})ₚ(MeSiO_{3/2})_{q}(MPSiO_{3/2})ᵣ(AcSiO_{3/2})ₛ

(MeViSiO_{2/2})ₚ(MeSiO_{3/2})_{q}(MPSiO_{3/2})ᵣ(MASiO_{3/2})ₛ

(MeViSiO_{2/2})ₚ(PhSiO_{3/2})_{q}(MeMPSiO_{2/2})ᵣ(Me₂AcSiO_{1/2})ₛ

(MeViSiO_{2/2})ₚ(PhSiO_{3/2})_{q}(MeMPSiO_{2/2})ᵣ(Me₂MASiO_{1/2})ₛ

(MeViSiO_{2/2})ₚ(PhSiO_{3/2})_{q}(MPSiO_{3/2})ᵣ(Me₂AcSiO_{1/2})ₛ

(MeViSiO_{2/2})ₚ(PhSiO_{3/2})_{q}(MPSiO_{3/2})ᵣ(Me₂MASiO_{1/2})ₛ

(MeViSiO_{2/2})ₚ(PhSiO_{3/2})_{q}(MPSiO_{3/2})ᵣ(MeAcSiO_{2/2})ₛ

(MeViSiO_{2/2})ₚ(PhSiO_{3/2})_{q}(MPSiO_{3/2})ᵣ(MeMASiO_{2/2})ₛ

(MeViSiO_{2/2})ₚ(PhSiO_{3/2})_{q}(MeMPSiO_{2/2})ᵣ(AcSiO_{3/2})ₛ

(MeViSiO_{2/2})ₚ(PhSiO_{3/2})_{q}(MeMPSiO_{2/2})ᵣ(MASiO_{3/2})ₛ

(MeViSiO_{2/2})ₚ(PhSiO_{3/2})_{q}(MPSiO_{3/2})ᵣ(AcSiO_{3/2})ₛ

(MeViSiO_{2/2})ₚ(PhSiO_{3/2})_{q}(MPSiO_{3/2})ᵣ(MASiO_{3/2})ₛ

(ViSiO_{3/2})ₚ(MeMPSiO_{2/2})_{q}(Me₂AcSiO_{1/2})ᵣ

(ViSiO_{3/2})ₚ(MeMPSiO_{2/2})_{q}(Me₂MASiO_{1/2})ᵣ

(ViSiO_{3/2})ₚ(MPSiO_{3/2})_{q}(Me₂ACSiO_{1/2})ᵣ

(ViSiO_{3/2})ₚ(MPSiO_{3/2})_{q}(Me₂MASiO_{1/2})ᵣ

(ViSiO_{3/2})ₚ(MeMPSiO_{2/2})_{q}(MeAcSiO_{2/2})ᵣ

(ViSiO_{3/2})ₚ(MeMPSiO_{2/2})_{q}(MeMASiO_{2/2})ᵣ

(ViSiO_{3/2})ₚ(MPSiO_{3/2})_{q}(MeAcSiO_{2/2})ᵣ

(ViSiO_{3/2})ₚ(MPSiO_{3/2})_{q}(MeMASiO_{2/2})ᵣ

(ViSiO_{3/2})ₚ(MeMPSiO_{2/2})_{q}(AcSiO_{3/2})ᵣ

(ViSiO_{3/2})ₚ(MeMPSiO_{2/2})_{q}(MASiO_{3/2})ᵣ

(ViSiO_{3/2})ₚ(MPSiO_{3/2})_{q}(AcSiO_{3/2})ᵣ

(ViSiO_{3/2})ₚ(MPSiO_{3/2})_{q}(MASiO_{3/2})ᵣ

(ViSiO_{3/2})ₚ(Me₂SiO_{2/2})_{q}(MeMPSiO_{2/2})ᵣ(Me₂AcSiO_{1/2})ₛ

(ViSiO_{3/2})ₚ(Me₂SiO_{2/2})_{q}(MeMPSiO_{2/2})ᵣ(Me₂MASiO_{1/2})ₛ

(ViSiO_{3/2})ₚ(Me₂SiO_{2/2})_{q}(MPSiO_{3/2})ᵣ(Me₂AcSiO_{1/2})ₛ

(ViSiO_{3/2})ₚ(Me₂SiO_{2/2})_{q}(MPSiO_{3/2})ᵣ(Me₂MASiO_{1/2})ₛ

(ViSiO_{3/2})ₚ(Me₂SiO_{2/2})_{q}(MeMPSiO_{2/2})ᵣ(MeAcSiO_{2/2})ₛ

(ViSiO_{3/2})ₚ(Me₂SiO_{2/2})_{q}(MeMPSiO_{2/2})ᵣ(MeMASiO_{2/2})ₛ

(ViSiO_{3/2})ₚ(Me₂SiO_{2/2})_{q}(MPSiO_{3/2})ᵣ(MeAcSiO_{2/2})ₛ

(ViSiO_{3/2})ₚ(Me₂SiO_{2/2})_{q}(MPSiO_{3/2})ᵣ(MeMASiO_{2/2})ₛ

(ViSiO_{3/2})ₚ(Me₂SiO_{2/2})_{q}(MeMPSiO_{2/2})ᵣ(AcSiO_{3/2})ₛ

(ViSiO_{3/2})ₚ(Me₂SiO_{2/2})_{q}(MeMPSiO_{2/2})ᵣ(MASiO_{3/2})ₛ

(ViSiO_{3/2})ₚ(Me₂SiO_{2/2})_{q}(MPSiO_{3/2})ᵣ(AcSiO_{3/2})ₛ

(ViSiO_{3/2})ₚ(Me₂SiO_{2/2})_{q}(MPSiO_{3/2})ᵣ(MASiO_{3/2})ₛ

(ViSiO_{3/2})ₚ(Ph₂SiO_{2/2})_{q}(MeMPSiO_{2/2})ᵣ(Me₂AcSiO_{1/2})ₛ

(ViSiO_{3/2})ₚ(Ph₂SiO_{2/2})_{q}(MeMPSiO_{2/2})ᵣ(Me₂MASiO_{1/2})ₛ

(ViSiO_{3/2})ₚ(Ph₂SiO_{2/2})_{q}(MPSiO_{3/2})ᵣ(Me₂AcSiO_{1/2})ₛ

(ViSiO_{3/2})ₚ(Ph₂SiO_{2/2})_{q}(MPSiO_{3/2})ᵣ(Me₂MASiO_{1/2})ₛ

(ViSiO_{3/2})ₚ(Ph₂SiO_{2/2})_{q}(MeMPSiO_{2/2})ᵣ(MeAcSiO_{2/2})ₛ

(ViSiO_{3/2})ₚ(Ph₂SiO_{2/2})_{q}(MeMPSiO_{2/2})ᵣ(MeMASiO_{2/2})ₛ

(ViSiO_{3/2})ₚ(Ph₂SiO_{2/2})_{q}(MPSiO_{3/2})ᵣ(MeAcSiO_{2/2})ₛ

(ViSiO_{3/2})ₚ(Ph₂SiO_{2/2})_{q}(MPSiO_{3/2})ᵣ(MeMASiO_{2/2})ₛ

(ViSiO_{3/2})ₚ(Ph₂SiO_{2/2})_{q}(MeMPSiO_{2/2})ᵣ(ACSiO_{3/2})ₛ

(ViSiO_{3/2})ₚ(Ph₂SiO_{2/2})_{q}(MeMPSiO_{2/2})ᵣ(MASiO_{3/2})ₛ

(ViSiO_{3/2})ₚ(Ph₂SiO_{2/2})_{q}(MPSiO_{3/2})ᵣ(AcSiO_{3/2})ₛ

(ViSiO_{3/2})ₚ(Ph₂SiO_{2/2})_{q}(MPSiO_{3/2})ᵣ(MASiO_{3/2})ₛ

(ViSiO_{3/2})ₚ(MePhSiO_{2/2})_{q}(MeMPSiO_{2/2})ᵣ(Me₂AcSiO_{1/2})ₛ

(ViSiO_{3/2})ₚ(MePhSiO_{2/2})_{q}(MeMPSiO_{2/2})ᵣ(Me₂MASiO_{1/2})ₛ

(ViSiO_{3/2})ₚ(MePhSiO_{2/2})_{q}(MPSiO_{3/2})ᵣ(Me₂AcSiO_{1/2})ₛ

(ViSiO_{3/2})ₚ(MePhSiO_{2/2})_{q}(MPSiO_{3/2})ᵣ(Me₂MASiO_{1/2})ₛ

(ViSiO_{3/2})ₚ(MePhSiO_{2/2})_{q}(MeMPSiO_{2/2})ᵣ(MeAcSiO_{2/2})ₛ

(ViSiO_{3/2})ₚ(MePhSiO_{2/2})_{q}(MeMPSiO_{2/2})ᵣ(MeMASiO_{2/2})ₛ

(ViSiO_{3/2})ₚ(MePhSiO_{2/2})_{q}(MPSiO_{3/2})ᵣ(MeAcSiO_{2/2})ₛ

(ViSiO_{3/2})ₚ(MePhSiO_{2/2})_{q}(MPSiO_{3/2})ᵣ(MeMASiO_{2/2})ₛ

(ViSiO_{3/2})ₚ(MePhSiO_{2/2})_{q}(MeMPSiO_{2/2})ᵣ(AcSiO_{3/2})ₛ

(ViSiO_{3/2})ₚ(MePhSiO_{2/2})_{q}(MeMPSiO_{2/2})ᵣ(MASiO_{3/2})ₛ

(ViSiO_{3/2})ₚ(MePhSiO_{2/2})_{q}(MPSiO_{3/2})ᵣ(AcSiO_{3/2})ₛ

(ViSiO_{3/2})ₚ(MePhSiO_{2/2})_{q}(MPSiO_{3/2})ᵣ(MASiO_{3/2})ₛ

(ViSiO_{3/2})ₚ(MeSiO_{3/2})_{q}(MeMPSiO_{2/2})ᵣ(Me₂AcSiO_{1/2})ₛ

(ViSiO_{3/2})ₚ(MeSiO_{3/2})_{q}(MeMPSiO_{2/2})ᵣ(Me₂MASiO_{1/2})ₛ

(ViSiO_{3/2})ₚ(MeSiO_{3/2})_{q}(MPSiO_{3/2})ᵣ(Me₂AcSiO_{1/2})ₛ

(ViSiO_{3/2})ₚ(MeSiO_{3/2})_{q}(MPSiO_{3/2})ᵣ(Me₂MASiO_{1/2})ₛ

(ViSiO_{3/2})ₚ(MeSiO_{3/2})_{q}(MeMPSiO_{2/2})ᵣ(MeAcSiO_{2/2})ₛ

(ViSiO_{3/2})ₚ(MeSiO_{3/2})_{q}(MeMPSiO_{2/2})ᵣ(MeMASiO_{2/2})ₛ

(ViSiO_{3/2})ₚ(MeSiO_{3/2})_{q}(MPSiO_{3/2})ᵣ(MeAcSiO_{2/2})ₛ

(ViSiO_{3/2})ₚ(MeSiO_{3/2})_{q}(MPSiO_{3/2})ᵣ(MeMASiO_{2/2})ₛ

(ViSiO_{3/2})ₚ(MeSiO_{3/2})_{q}(MeMPSiO_{2/2})ᵣ(AcSiO_{3/2})ₛ

(ViSiO_{3/2})ₚ(MeSiO_{3/2})_{q}(MeMPSiO_{2/2})ᵣ(MASiO_{3/2})ₛ

(ViSiO_{3/2})ₚ(MeSiO_{3/2})_{q}(MPSiO_{3/2})ᵣ(AcSiO_{3/2})ₛ

(ViSiO_{3/2})ₚ(MeSiO_{3/2})_{q}(MPSiO_{3/2})ᵣ(MASiO_{3/2})ₛ

(ViSiO_{3/2})ₚ(PhSiO_{3/2})_{q}(MeMPSiO_{2/2})ᵣ(Me₂AcSiO_{1/2})ₛ

(ViSiO_{3/2})ₚ(PhSiO_{3/2})_{q}(MeMPSiO_{2/2})ᵣ(Me₂MASiO_{1/2})ₛ

(ViSiO_{3/2})ₚ(PhSiO_{3/2})_{q}(MPSiO_{3/2})ᵣ(Me₂ACSiO_{1/2})ₛ

(ViSiO_{3/2})ₚ(PhSiO_{3/2})_{q}(MPSiO_{3/2})ᵣ(Me₂MASiO_{1/2})ₛ

(ViSiO_{3/2})ₚ(PhSiO_{3/2})_{q}(MeMPSiO_{2/2})ᵣ(MeACSiO_{2/2})ₛ

(ViSiO_{3/2})ₚ(PhSiO_{3/2})_{q}(MeMPSiO_{2/2})ᵣ(MeMASiO_{2/2})ₛ

(ViSiO_{3/2})ₚ(PhSiO_{3/2})_{q}(MPSiO_{3/2})ᵣ(MeAcSiO_{2/2})ₛ

(ViSiO_{3/2})ₚ(PhSiO_{3/2})_{q}(MPSiO_{3/2})ᵣ(MeMASiO_{2/2})ₛ

(ViSiO_{3/2})ₚ(PhSiO_{3/2})_{q}(MeMPSiO_{2/2})ᵣ(AcSiO_{3/2})ₛ

(ViSiO_{3/2})ₚ(PhSiO_{3/2})_{q}(MeMPSiO_{2/2})ᵣ(MASiO_{3/2})ₛ

(ViSiO_{3/2})ₚ(PhSiO_{3/2})_{q}(MPSiO_{3/2})ᵣ(AcSiO_{3/2})ₛ

(ViSiO_{3/2})ₚ(PhSiO_{3/2})_{q}(MPSiO_{3/2})ᵣ(MASiO_{3/2})ₛ

In the composition (M1), the content of component (A2) in various embodiments is in the range of about 0.1 to about 50.0 parts by mass, optionally in the range of about 0.1 to about 30 parts by mass, or optionally in the range of about 0.5 to about 20 parts by mass, per 100 parts by mass of the sum of components (A1) and (A2). This is because, when the content of component (A2) is greater than or equal to the lower limit of the range described above, reduction in transmittance of the cured product at a high temperature/high humidity becomes small. On the other hand, when the content is less than or equal to the upper limit of the range described above, change in hardness of the cured product at a high temperature is made small and coloring is reduced.

In the composition (M2), the content of component (A3) in various embodiments is an amount that the amount of the mercapto groups in component (A3) is in the range of about 0 to about 3 moles, and optionally in the range of about 0 to about 2 moles, per 1 mole of the total acryl group-containing organic groups and/or methacrylic group-containing organic groups in component (A1). This is because, when the content of component (A3) is greater than or equal to the lower limit of the range described above, curability of the composition is enhanced. On the other hand, when the content is less than or equal to the upper limit of the range described above, change in hardness of the cured product at a high temperature is made small and coloring is reduced.

In the composition (M3), the content of component (A5) in various embodiments is an amount that the amount of the mercapto groups in component (A5) is in the range of about 0.2 to about 3 moles, and optionally in the range of about 0.5 to about 2 moles, per 1 mole of the alkenyl groups in component (A4). This is because, when the content of component (A5) is greater than or equal to the lower limit of the range described above, the composition can be cured sufficiently. On the other hand, when the content is less than or equal to the upper limit of the range described above, change in hardness of the cured product at a high temperature is made small and coloring is reduced.

In the composition (M4), the content of component (A2) is not limited, but in various embodiments it is in the range of about 0.1 to about 50.0 parts by mass, optionally in the range of about 0.1 to about 30 parts by mass, or optionally in the range of about 0.5 to about 20 parts by mass, per 100 parts by mass of the sum of components (A1) and (A2). This is because, when the content of component (A2) is greater than or equal to the lower limit of the range described above, reduction in transmittance of the cured product at a high temperature/high humidity becomes small. On the other hand, when the content is less than or equal to the upper limit of the range described above, change in hardness of the cured product at a high temperature is made small and coloring is reduced.

In the composition (M4), the content of component (A3) in various embodiments is an amount that the amount of the mercapto groups in component (A3) is in the range of about 0.1 to about 3 moles, and optionally in the range of about 0.5 to about 2 moles, per 1 mole of the total of the acryl group-containing organic groups and/or methacryl group-containing organic groups in component (A1) and the alkenyl groups in component (A2). This is because, when the content of component (A3) is greater than or equal to the lower limit of the range described above, the composition can be cured sufficiently. On the other hand, when the content is less than or equal to the upper limit of the range described above, change in hardness of the cured product at a high temperature is made small and coloring is reduced.

In the composition (M5), the content of component (A3) in various embodiments is an amount that the amount of the mercapto groups in component (A6) is in the range of about 0 to about 3 moles, and optionally in the range of about 0.5 to about 2 moles, per 1 mole of the total of the acryl group-containing organic groups and/or methacryl group-containing organic groups and the alkenyl groups in component (A6). This is because, when the content of component (A3) is greater than or equal to the lower limit of the range described above, the composition can be cured sufficiently. On the other hand, when the content is less than or equal to the upper limit of the range described above, change in hardness of the cured product at a high temperature is made small and coloring is reduced.

Component (B) is an organosilicon compound having at least one photo-active organic group and having at most about 200 silicon atoms per molecule, wherein the organosilicon compound is activated when it is exposed to light of a wavelength of from 300 to 420 nm.

Examples of the photo-active organic groups in component (B) include groups represented by the following formulae (a)-(q):

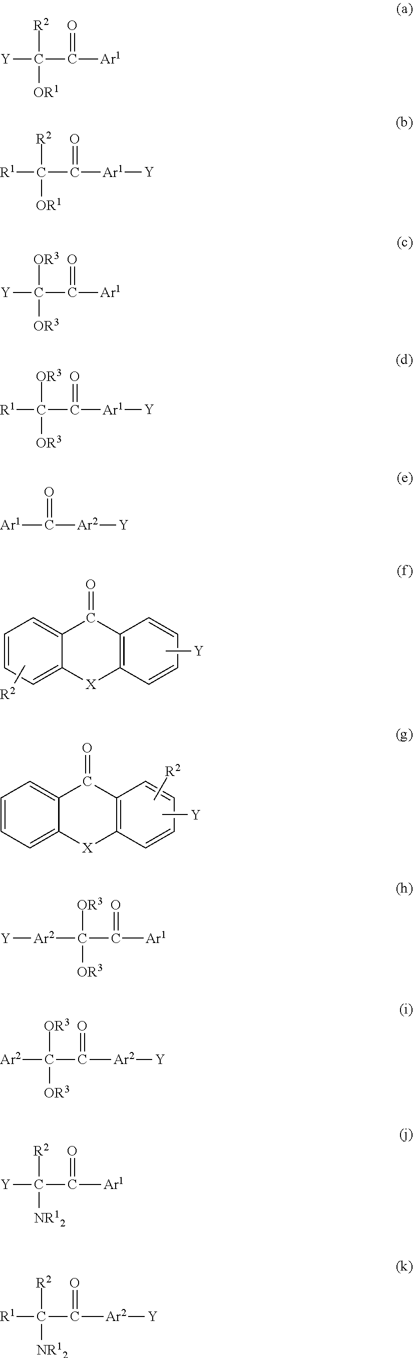

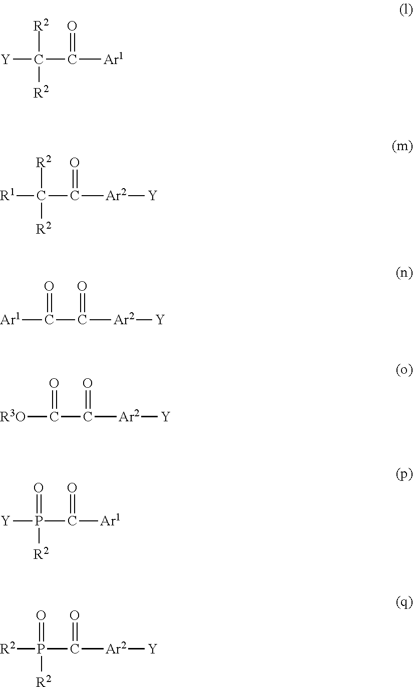

In the formulae, R¹ is a hydrogen atom or an alkyl group having 1 to 12 carbon atoms. Examples of the alkyl groups for R¹ include methyl groups, ethyl groups, propyl groups, butyl groups, pentyl groups, hexyl groups, heptyl groups, octyl groups, nonyl groups, decyl groups, undecyl groups, and dodecyl groups. In certain embodiments, at least one R¹ is a methyl group.

In the formulae, R² is an alkyl group having 1 to 12 carbon atoms, an aryl group having 6 to 20 carbon atoms, an aralkyl group having 7 to 20 carbon atoms, a halogen atom-, an amino group- or a hydroxyl group-substituted alkyl group having 1 to 12 carbon atoms, a halogen atom-, an amino group- or a hydroxyl group-substituted aryl group having 6 to 20 carbon atoms, or a halogen atom.

Examples of the alkyl groups for R² include the alkyl groups for R¹ as described above.

Examples of the halogen atom-, amino group- or hydroxyl group-substituted alkyl groups for R² include 1-chloromethyl groups, 2-chloroethyl groups, 3-chloropropyl groups, 3,3,3-trifluoropropyl groups, 3-aminopropyl groups, 2-aminoethyl-3-aminopropyl groups, butyl groups, 3,3,3-trifluoropropyl groups, and 3-hydroxypropyl groups.

Examples of the aryl groups for R² include phenyl groups, tolyl groups, xylyl groups, and naphthyl groups. In certain embodiments, at least one R² is a phenyl group.

Examples of the halogen atom-, amino group- or hydroxyl group-substituted aryl groups for R² include chlorophenyl groups, aminophenyl groups, and hydroxyphenyl groups.

Examples of the aralkyl groups for R² include benzyl groups, phenethyl groups, and phenylpropyl groups. In certain embodiments, at least one R² is a phenethyl group.

In the formulae, R³ is an alkyl group having 1 to 12 carbon atoms. Examples of the alkyl groups for R³ include the alkyl groups for R¹ as described above.

In the formulae, Ar¹ is an aryl group having 6 to 20 carbon atoms, or a halogen atom-, an amino group- or a hydroxyl group-substituted aryl group having 6 to 20 carbon atoms.

Examples of the aryl groups for Ar¹ include the aryl groups for R² as described above.

Examples of the halogen atom-, amino group- or hydroxyl group-substituted aryl groups for Ar¹ include the halogen atom-, amino group- or hydroxyl group-substituted aryl groups for R² as described above.

In the formulae, Ar² is an arylene group having 6 to 20 carbon atoms, or a halogen atom-, an amino group- or a hydroxyl group-substituted arylene group having 6 to 20 carbon atoms.

Examples of the arylene groups for Ar² include 1,4-phenylene groups, 1,2-phenylene groups, and 2-methyl-1,4-phenylene groups. In certain embodiments, at least one Ar² is a 1,4-phenylene group. Examples of the halogen atom-, amino group- or hydroxyl group-substituted arylene groups for Ar² include 2-chloro-1,4-phenylene groups, 2-amino-1,4-phenylene groups, and 2-hydroxy-1,4-phenylene groups.

In the formulae, X is an oxygen atom or a sulfur atom.

In the formulae, Y is a divalent bond connecting with a Si atom in component (B).

In various embodiments, component (B) is an organosilicon compound represented by the following average compositional formula (I):

ZₐR⁴_{b}SiO_{(4-a-b)/2} (I)

In the formula (I), R⁴ is an alkyl group having 1 to 12 carbon atoms, alkenyl group having 2 to 12 carbon atoms, aryl group having 6 to 20 carbon atoms, alkoxy group having 1 to 6 carbon atoms, or a hydroxyl group.

Examples of the alkyl groups for R⁴ include methyl groups, ethyl groups, propyl groups, butyl groups, pentyl groups, hexyl groups, heptyl groups, octyl groups, nonyl groups, decyl groups, undecyl groups, and dodecyl groups. In certain embodiments, at least one R⁴ is a methyl group.

Examples of the alkenyl groups for R⁴ include vinyl groups, allyl groups, isopropenyl groups, butenyl groups, pentenyl groups, hexenyl groups, cyclohexenyl groups, and octenyl groups. In certain embodiments, at least one R⁴ is a vinyl group and/or at least one R⁴ is an allyl group.

Examples of the aryl groups for R⁴ include phenyl groups, tolyl groups, xylyl groups, and naphthyl groups. In certain embodiments, at least one R⁴ is a phenyl group.

Examples of the alkoxy groups for R⁴ include methoxy groups, ethoxy groups, propoxy groups, and butoxy groups. In certain embodiments, at least one R⁴ is a methoxy group.

In the formula (I), Z in various embodiments is an acylphosphinate residue represented by the following general formula (II):

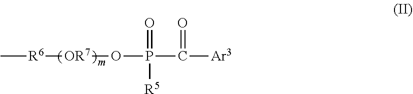

In the formula (II), R⁵ is a non-substituted or a halogen-substituted alkyl group having 1 to 12 carbon atoms, a non-substituted or a halogen-substituted aryl group having 6 to 20 carbon atoms, an aralkyl group having 7 to 20 carbon atoms, or an alkoxy group having 1 to 6 carbon atoms.

Examples of the non-substituted or halogen-substituted alkyl groups for R⁵ include methyl groups, ethyl groups, propyl groups, butyl groups, pentyl groups, hexyl groups, heptyl groups, octyl groups, nonyl groups, decyl groups, undecyl groups, dodecyl groups, 3-chloropropyl groups, 3,3,3-trifluoropropyl groups. In certain embodiments, at least one R⁵ is a methyl group.

Examples of the non-substituted or halogen-substituted aryl groups for R⁵ include phenyl groups, tolyl groups, xylyl groups, mesityl groups, naphthyl groups, chlorophenyl groups, dichlorophenyl groups, and trichlorophenyl groups. In certain embodiments, at least one R⁵ is a phenyl group.

Examples of the aralkyl groups for R⁵ include benzyl groups, phenethyl groups, and phenylpropyl groups. In certain embodiments, at least one R⁵ is a phenethyl group.

Examples of the alkoxy groups for R⁵ include methoxy groups, ethoxy groups, propoxy groups, and butoxy groups. In certain embodiments, at least one R⁵ is a methoxy group.

In the formula (II), R⁶ is a linear or branched alkylene group having 1 to 12 carbon atoms. Examples of the alkylene groups for R⁶ include methylene groups, 1,1-ethylene groups, 1,2-ethylene groups, 1,2-propylene groups, 1,3-propylene groups, and 1,4-butylene groups. In certain embodiments, at least one R⁶ is a 1,3-propylene group.

In the formula (II), R⁷ is an alkylene group having 2 to 6 carbon atoms. Examples of the alkylene groups for R⁷ include 1,2-ethylene groups, 1,2-propylene groups, 1,3-propylene groups, and 1,4-butylene groups. In certain embodiments, at least one R⁷ is a 1,2-ethylene group and/or at least one R⁷ is a 1,2-propylene group.

In the formula (II), Ar³ is a non-substituted, alkoxy-substituted, or a halogen-substituted aryl group having 6 to 20 carbon atoms. Examples of the non-substituted, alkoxy-substituted, or halogen-substituted aryl groups for Ar³ include phenyl groups, tolyl groups, xylyl groups, mesityl groups, naphthyl groups, methoxyphenyl groups, dimethoxyphenyl groups, chlorophenyl groups, dichlorophenyl groups, and trichlorophenyl groups.

In the formula (II), “m” is an integer of from 0 to 100, optionally an integer of from 0 to 50, optionally an integer of from 0 to 10, or optionally an integer of from 0 to 5. This is because, when “m” is equal to or greater than the lower limit of the range described above, the molecular weight of the organosilicon compound can be increased high, and volatility of the organosilicon compound can be reduced. On the other hand, when “m” is equal to or less than the upper limit of the range described above, curability of a photo-curable silicone composition comprising the organosilicon compound as a photo-initiator can be enhanced.

In the formula (II), “a” and “b” are numbers satisfying the following conditions: 0<a≤2, 0<b≤3, and a≤b, optionally “a” and “b” are numbers satisfying the following conditions: a+b≤3, or optionally “a” and “b” are numbers satisfying the following conditions: 1.5≤a+b≤2.3. This is because, when “a” is equal to or greater than the lower limit of the range described above, curability of a photo-curable silicone composition comprising the organosilicon compound as a photo-initiator can be enhanced. On the other hand, when “a” is equal to or less than the upper limit of the range described above, compatibility of the organosilicon compound with organopolysiloxanes can be enhanced. While, when “b” is equal to or greater than the lower limit of the range described above, compatibility of the organosilicon compound with organopolysiloxanes can be enhanced. On the other hand, when “b” is equal to or less than the upper limit of the range described above, curability of a photo-curable silicone composition comprising the organosilicon compound as a photo-initiator can be enhanced.

The organosilicon compound has not more than 200 silicon atoms per molecule. In various embodiments, a number of silicon atoms per molecule is in a range of from 1 to 100, optionally in a range of from 5 to 50, optionally in a range of from 5 to 30, or optionally in a range of from 5 to 20. It is thought that when the number of silicon atoms is greater than or equal to the lower limit of the range described above, compatibility of the organosilicon compound with organopolysiloxanes can be enhanced. On the other hand, when it is equal to or less than the upper limit of the range described above, curability of a photo-curable silicone composition comprising the organosilicon compound as a photo-initiator can be enhanced.

In various embodiments, such organosilicon compound is an organosiloxane represented by the following general formula (III):

R⁸₃SiO(R⁸₂SiO)ₙSiR⁸₃ (III)

In the formula (III), R⁸ is the same or different, R⁴ and/or Z as described above. However, per molecule, at least one R⁸ is Z as described above.

In the formula (III), “n” is an integer of from 0 to 198, optionally an integer of from 0 to 98, optionally an integer of from 0 to 48, optionally an integer of from 0 to 28, or optionally an integer of from 0 to 18. This is because, when “n” is equal to or greater than the lower limit of the range described above, the molecular weight of the organosilicon compound can be increased, and volatility of the organosilicon compound can be reduced. On the other hand, when “n” is equal to or less than the upper limit of the range described above, curability of a photo-curable silicone composition comprising the organosilicon compound as a photo-initiator can be enhanced.

State of the organosilicon compound at 25° C. is not limited, but in various embodiments it is liquid.

A method for producing the organosilicon compound is not limited, but in various embodiments it is a method comprising the following steps i) and ii) to yield an organosilicon compound with a acylphosphinate residue:

In step i), an organosilicon compound represented by the following compositional formula (IV):

R⁹ₐR⁴_{b}SiO_{(4-a-b)/2} (IV)

is reacted with an organophosphine represented by the following general formula (VI):

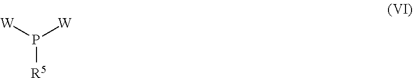

In the formula (IV), R⁴, “a” and “b” are as described above.

In the formula (IV), R⁹ is a group represented by the following general formula (V):

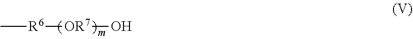

In the formula (V), R⁶, R⁷ and “m” are as described above.

In the formula (VI), R⁵ is as described above.

In the formula (VI), W are the same or different halogen atoms. Examples of halogen atoms for W include fluorine atoms, chlorine atoms, bromine atoms and iodine atoms, and chlorine atoms. In certain embodiments, at least one W is a bromine atom.

In step i), the equivalent amount of the hydroxyl groups in the organosilicon compound (IV) described above should be reacted with the halogen atoms in the organophoshine compound (VI). In various embodiments, the reaction is performed in amounts where 0.5 mol to 2 mol, or optionally 0.75 mol to 1.5 mol, of the hydroxyl groups in the organosilicon compound (IV) is reacted with 1 mol of the halide group in the organophoshine compound (VI).

In step i), the reaction is carried out in the presence of a hydrogen halide acceptor. Examples of the hydrogen halide acceptors include tertiary amines such as trimethylamine, triethylamine, tri-n-propylamine, tri-n-butylamine, tri-i-butylamine, tri-n-hexylamine, tri-n-octylamine, triphenylamine, N,N-dimethylaniline, N,N-diethylaniline, dimethyl cyclohexylamine, diethyl cyclohexylamine, 1-methylpiperidine, and pyridine; secondary amines such as dimethylamine, diethylamine, and piperazine; primary amines such as butylamine and aniline; and inorganic salts such as sodium hydroxide, potassium hydroxide, and ammonia. In various embodiments, the reaction is carried out in the presence of a tertiary amine.

In step i), an organic solvent may be used in the preparation method described above. The utilized organic solvent is exemplified by ethers, aromatic or aliphatic hydrocarbons, and mixtures of two or more types of such solvents. In various embodiments, an organic solvent is utilized and selected from the group of hexane, heptane, octane, toluene, and xylene.

In step i), a reaction temperature is not limited, but in various embodiments it is in a range of from about room temperature to about 150° C. In step i), the reaction is promoted by the presence of hydrogen halide acceptor. When an organic solvent is used, the reaction is generally performed at room temperature or lower but above freezing point of the organic solvent.

Next, in step ii), following the Arbuzov-Michaelis reaction, the reaction product obtained by step i) is reacted with a carboxylic halide represented by the following general formula (VII):

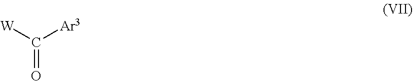

In the formula (VII), W and Ar³ are as described above.

In step ii), the equivalent amount of the reaction product obtained by step i) described above should be reacted with the halogen atom in the carboxylic halide (VII). In various embodiments, the reaction is performed in amounts where 0.5 mol to 2 mol, or optionally 0.75 mol to 1.5 mol, of the reaction product obtained by step i) is reacted with 1 mol of the carboxylic halide (VII).

In step ii), an organic solvent may be used in the preparation method described above. The utilized organic solvent is exemplified by ethers, aromatic or aliphatic hydrocarbons, and mixtures of two or more types of such solvents. In various embodiments, an organic solvent is utilized and selected from the group of hexane, heptane, octane, toluene, and xylene.

In step ii), a reaction temperature is not limited, but in various embodiments it is in a range of from about room temperature to about 150° C. In step ii), the reaction is promoted by heating. When an organic solvent is used, the reaction is generally performed at the reflux temperature of the organic solvent.

In various embodiments, the amount of component (B) is within a range of 0.01 to 5 mass parts, optionally within a range of 0.01 to 3 mass parts, optionally within a range of 0.05 to 3 mass parts, or optionally within a range of 0.05 to 2 mass parts, with regard to 100 parts by mass of component (A). This is because if the amount of component (B) is above the lower limit of the range, the curing properties of the composition obtained will the favorable; however, if, on the other hand, the amount is below the upper limit of the aforementioned range, the heat resistance and light resistance of the cured product obtained will be favorable.

The composition of the present invention may comprise a hindered phenol compound for maintaining favorable storage stability of the composition and providing heat resistance to the cured product. Examples of the hindered phenol compounds include 2,6-bis (hydroxymethyl)-p-cresol, 2,6-di-tert-butyl-4-methylphenol, 2,6-di-tert-butyl-4-hydroxymethylphenol, pentaerythritol tetrakis[3-(3,5-di-tert-butyl-4-hydroxyphenyl) propionate], thiodiethylene bis[3-(3,5-di-tert-butyl-4-hydroxyphenyl) propionate], octadecyl-3-(3,5-di-tert-butyl-4-hydroxyphenyl) propionate, 2,4-dimethyl-6-(1-methylpentadecyl) phenol, diethyl[{3,5-bis(1,1-di-tert-butyl-4-hydroxy phenyl) methyl} phosphonate, 3,3′,3″,5,5′,5″-hexane-tert-butyl-4-a,a′,a″-(mesitylene-2,4,6-tolyl) tri-p-cresol, 4,6-bis(octylthiomethyl)-o-cresol, ethylenebis (oxyethylene) bis[3-(5-tert-butyl-4-hydroxy-m-tolyl) propionate], and hexamethylenebis[3-(3,5-di-tert-butyl-4-hydroxyphenyl) propionate].

The amount of the hindered phenol compound is not limited, but in various embodiments it is within a range of 0.001 to 1 mass parts, optionally within a range of 0.01 to 1 mass parts, or optionally within a range of 0.01 to 0.5 mass parts, with regard to a total of 100 mass parts of components (A) and (B). This is because if the amount of the hindered phenol compound is above the lower limit of the range, the storage stability of the composition obtained will the favorable; however, if, on the other hand, the amount is below the upper limit of the aforementioned range, the heat resistance and light resistance of the cured product obtained will be favorable.

Furthermore, so long as the object of the present invention is not hindered, the composition can contain conventionally known additives as necessary, in addition to the aforementioned components, with examples including: metal oxide fine powders such as fumed silica, wet silica, and the like; adhesion promoters such as vinyl triethoxysilane, allyl trimethoxysilane, allyl triethoxysilane, 3-glycidoxypropyl trimethoxysilane and the like; low molecular weight siloxane containing an alkenyl group as a reactive solvent, such as 1,1,3,3-tetramethyl-1,3-divinyldisiloxane, 1,3,5,7-tetramethyl-1,3,5,7-tetravinylcyclotetrasiloxane, and the like; and heat resistance enhancing agents such as N-nitrosophenylhydroxylamine aluminum salt, and the like.

The present compositions can be used as a solvent-free form, but dilution with solvent is acceptable in order to reduce the composition's viscosity and to prepare thin coating. Examples of solvents include toluene, xylene, hexane, heptane, and mixtures thereof.

The amount of solvent is not limited, but in various embodiments it is in the range of from 0 to 3,000 parts by mass, or optionally in the range of from 0 to 1,000 parts by mass, per 100 parts by mass of the sum of components (A) and (B).

While the viscosity of the present invention at 23° C. is not limited, in various embodiments it is 100,000 mPa·s or less, optionally within a range of 100 to 100,000 mPa·s, or optionally within a range of 500 to 10,000 mPa·s. This is because if the viscosity of the composition is above the lower limit of the range, the mechanical properties of the cured product obtained will be favorable; however, if, on the other hand, the viscosity is below the upper limit of the aforementioned range, the coatability of the composition obtained will be enhanced and the formation of voids in the cured product can be avoided.

The present composition can be produced by blending to uniformity components (A) and (B), and if necessary, other arbitrary components. When preparing this composition, mixing can be performed at room temperature using various types of mixers or kneaders, and if necessary, mixing can be performed while heating. Furthermore, the order of combining the various components is not restricted, and mixing can be performed in any order. On the other hand, in order to avoid the effect of curing during preparation of the composition, it is recommended that preparation be performed in a location without exposure to light with a wavelength of 450 nm or less, or in an area where mixing of the aforementioned light is restricted as far as possible.

The present composition can be cured by light irradiation. While the light used for curing the composition can be ultraviolet light or visible light, for example, the wavelength of the light in various embodiments is within a range of from 250 to 500 nm, or optionally within a range of from 300 to 420 nm, with the composition thereof having curing properties by visible light with a wavelength of 400 nm or longer (for example, an LED light source with a wavelength of 405 nm).

This composition is useful as various types of potting agents, sealing agents, adhesives, and encapsulants with the cured product thereof having minimal discoloration and not readily clouding under high temperature or high temperature and high humidity conditions, thereby allowing it to be suitably used as a material for forming intermediate layers between the image display part and the protective part of an image display device.

The composition cures at room temperature, allowing it to be suitably used for coating substrates with poor heat resistance. The type of substrate is generally a transparent substrate such as glass, and synthetic resin films, sheets, and coatings, and the like. Furthermore, the application method of the composition can be, for example, gravure coating, microgravure coating, slit coating, slot die coating, screen printing, or comma coating.

### <Cured Product>

Next, the cured product of the present invention will be described in detail. The cured product is obtained by exposing the photo-curable organopolysiloxane composition as described above to light of a wavelength of from 300 to 420 nm. While the shape of the cured product is not particularly limited, examples include sheets, films, tapes, and lumps. Furthermore, integrating with various types of substrates is also possible.

The forming method of the cured product can be a method of applying the composition to a film shaped substrate, tape shaped substrate, or sheet shaped substrate, then curing by irradiating light forming a cured film made of the cured product on the surface of the substrate. The film thickness of the cured film is not restricted, but in various embodiments the film thickness is 1 to 3000 μm, or optionally 40 to 3000 μm. Among the cured products, a laminate comprising an optical material and a cured product as described above may be desirable.

### EXAMPLES

The photo-curable organopolysiloxane composition of the present invention and cured product thereof are described below in further detail using examples. Note that in the examples, measurements and evaluations were performed as described below.

### <Viscosity of Photo-Curable Organopolysiloxane Compositions and Various Components>

The viscosity (mPa·s) at 23° C. of the photo-curable organopolysiloxane composition and various components was measured using an E type viscometer VISCONIC EMD manufactured by TOKIMEC CORPORATION.

### <Appearance of Photo-Curable Organopolysiloxane Compositions>

The photo-curable organopolysiloxane compositions were observed by visual inspection.

### <Curing of Photo-Curable Organopolysiloxane Compositions>

Into a glass vessel had a depth of 15 mm and an inner diameter of 30 mm, a photo-curable composition was filled. Then, ultraviolet light was irradiated using a LED lamp with 405 nm of 50 mW/cm² for 20 seconds to form a cured product.

### <Hardness of Cured Products>

The Shore A hardness of the obtained cured products was measured using type A durometer as measured in accordance with ASTM D2240. The needle penetration of the obtained cured product was measured using a needle penetration stipulated with ¼ cone accordance with JIS K 2220.

### <Appearance of Cured Products>

The cured products were observed by visual inspection.

### Reference Example 1

In a reaction vessel under a N₂ atmosphere in a glovebox, 1.56 g of dichlorophenylphosphine and 150 ml of hexane were placed, then 8.25 g of 3-hydroxypropyl group-containing dimethylpolysiloxane represented by the following formula:

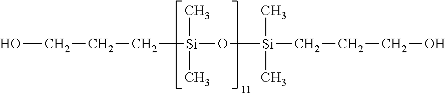

and 2.38 g of triethylamine and 20 ml of hexane were added while stirring. White precipitate was produced. The reaction mixture was stirred at room temperature for 30 min. As a result of ¹H-NMR analysis, it was found that the 3-hydroxypropyl group-containing dimethylpolysiloxane was completely reacted. After filtering off the white precipitate, hexane was distilled at reduced pressure, then a colorless liquid was obtained.

The colorless liquid was loaded into a 250 ml Schlenk's flask with 70 ml of absolute toluene. 1.55 g of 2,4,6-trimethylbenzoyl chloride was added while stirring the mixture, and reacted at 80° C. under a N₂ flow for 12 hours. After confirming completion of the reaction by ³¹P-NMR analysis, the reaction mixture was washed by saturated sodium hydrocarbonate aqueous solution, dried over magnesium sulfate, then filtered. Low boiling point components were removed under reduced pressure to obtain 3.26 g of a light yellow liquid. As a result of ¹H-NMR analysis, it was found that the liquid comprises:

an organosilicon compound represented by the following formula:

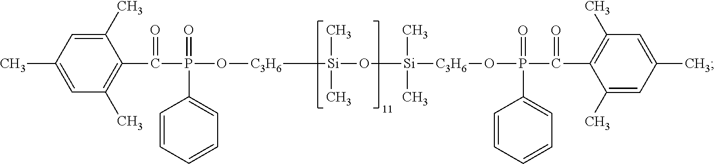

an organosilicon compound represented by the following formula:

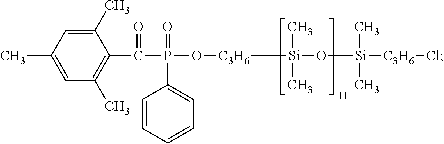

and
about 25 mol % of a dimethylpolysiloxane represented by the following formula:

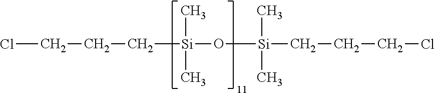

### Examples 1 to 6 and Comparative Example 1

Photocurable organopolysiloxane compositions were prepared from the following components using the composition (mass parts) shown in Table 1. Note that the photocurable organopolysiloxane compositions of Practical Examples 1 to 4 and Comparative Example 1 were prepared to provide 1 mol of 3-mercaptopropyl group with regard to 1 mol of vinyl groups.

The following components were used as component (A).

Component (a-1): a linear dimethylpolysiloxane capped at both molecular terminals with dimethylvinylsiloxy groups and having a viscosity at 23° C. of 43,000 mPa·s
Component (a-2): a linear dimethylpolysiloxane capped at both molecular terminals with dimethylvinylsiloxy groups and having a viscosity at 23° C. of 2,300 mPa·s
Component (a-3): a branched dimethylpolysiloxane capped at four molecular terminals with dimethylvinylsiloxy groups per molecule and having a viscosity at 23° C. of 200 mPa·s
Component (a-4): a linear dimethylsiloxane and and methyl(3-mercaptopropyl)siloxane copolymer capped at both molecular terminals with trimethylsiloxy groups, and having a viscosity at 23° C. of 100 mPa·s and a content of hydrogen atoms originated from thiol groups being 0.12 mass %
Component (a-5): 1,1,3,3-tetramethyl-1,3-di(3-methacryloxypropyl)-disiloxane
Component (a-6): 3-methacryloxypropyl-tris[tris(trimethylsiloxy)silyl ethyl dimethylsiloxy] silane

The following components were used as component (B).

Component (b-1): the organosilicon compound prepared in Reference Example 1
Component (b-2): a phosphine compound represented by the following formula:

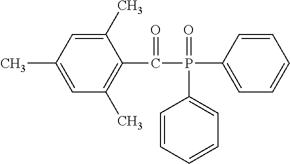 [SMILES: Cc1cc(C)c(C(=O)P(=O)(c2ccccc2)c2ccccc2)c(C)c1]

TABLE 1-A

| | | | Category | | | |
|---|---|---|---|---|---|---|
| | | | Prac. | Prac. | Prac. | Prac. |
| Item | | | Exam. 1 | Exam. 2 | Exam. 3 | Exam. 4 |
| Composition of | (A) | (a-1) | 97.9 | — | — | — |
| photo-curable | | (a-2) | — | 95.6 | — | — |
| organopolysiloxane | | (a-3) | — | — | 85.5 | 78.0 |
| composition | | (a-4) | 1.6 | 3.9 | 14.0 | 21.5 |
| (parts by mass) | | (a-5) | — | — | — | — |
| | | (a-6) | — | — | — | — |
| | (B) | (b-1) | 0.5 | 0.5 | 0.5 | 0.5 |
| | | (b-2) | — | — | — | — |

| Appearance | | Transparent | Transparent | Transparent | Transparent |
|---|---|---|---|---|---|
| Viscosity at 23° C. (mPa · s) | | 40,000 | 2,170 | 180 | 170 |
| Cured | Appearance | Transparent | Transparent | Transparent | Transparent |
| Product | Penetration | 28 | 25 | — | — |
| | Shore 00 Hardness | — | — | 50 | 74 |

TABLE 1-B

| | | | Category | | |
|---|---|---|---|---|---|
| | | | Prac. | Prac. | Comp. |
| Item | | | Exam. 5 | Exam. 6 | Exam. 1 |
| Composition of | (A) | (a-1) | — | — | — |
| photo-curable | | (a-2) | — | — | 95.4 |
| organopolysiloxane | | (a-3) | — | — | — |
| composition | | (a-4) | — | — | 4.4 |
| (parts by mass) | | (a-5) | 99.5 | — | — |
| | | (a-6) | — | 99.5 | — |
| | (B) | (b-1) | 0.5 | 0.5 | — |
| | | (b-2) | — | — | 0.2 |

| Appearance | | Transparent | Transparent | Milky- |
|---|---|---|---|---|
| | | | | white |
| Viscosity at 23° C. (mPa · s) | | 7 | 69 | — |
| Cured | Appearance | Transparent | Transparent | Did not |
| Product | | | Partially | cure |
| | | | cured | |
| | Penetration | 78 | — | — |
| | Shore 00 Hardness | — | — | — |

### INDUSTRIAL APPLICABILITY

The photo-curable organopolysiloxane composition of the present invention quickly cures by irradiation with long wavelength light, for example, visible light having a wavelength of 405 nm, and forms a cured product with transparency, making it useful as a protective film or adhesive for optical displays, and in particular, also allowing it to be applied to displays in which the cover material is a plastic material such as polycarbonate.

1. A photo-curable organopolysiloxane composition comprising:
(A) 100 parts by mass of a photo-curable organopolysiloxane; and
(B) 0.01 to 5.0 parts by mass of an organosilicon compound having at least one photo-active organic group and having at most 200 silicon atoms per molecule, wherein the organosilicon compound is activated when it is exposed to light of a wavelength of from 300 to 420 nm.

2. The photo-curable organopolysiloxane composition according to claim 1, wherein component (A) is an organopolysiloxane having at least one photo-reactive organic group per molecule.

3. The photo-curable organopolysiloxane composition according to claim 2, wherein the at least one photo-reactive organic group in component (A) is selected from the group consisting of an acryl group-containing organic group, a methacryl group-containing organic group, an alkenyl group, a mercapto group-containing organic group, and combinations thereof.

4. The photo-curable organopolysiloxane composition according to claim 1, wherein component (A) is a photo-curable organopolysiloxane selected from the group consisting of the following compositions (M1) to (M7):
Composition (M1):
(A1) an organopolysiloxane having at least one of an acryl group-containing organic group and/or a methacryl group-containing organic group per molecule; and
(A2) an organopolysiloxane having at least one alkenyl group having 2 to 12 carbon atoms per molecule and free of a mercapto group-containing organic group, in an amount that the content of component (A2) is 0.1 to 50.0 parts by mass per 100 parts by mass of the sum of components (A1) and (A2);
Composition (M2):
(A1) an organopolysiloxane having at least one of an acryl group-containing organic group and/or a methacryl group-containing organic group per molecule; and
(A3) an organocompound having at least one mercapto group-containing organic group per molecule, in an amount that the mercapto groups in component (A3) is 0 to 3 moles per 1 mole of the acryl group-containing organic groups and/or methacryl group-containing organic groups in component (A1);
Composition (M3):
(A4) an organopolysiloxane having at least two alkenyl groups having 2 to 12 carbon atoms per molecule and free of a mercapto group-containing organic group; and
(A5) an organocompound having at least two mercapto group-containing groups per molecule, in an amount that the mercapto groups in component (A5) is 0.2 to 3 moles per 1 mole of the alkenyl groups in component (A4);
Composition (M4):
(A1) an organopolysiloxane having at least one of an acryl group-containing organic group and/or a methacryl group-containing organic group per molecule;
(A2) an organopolysiloxane having at least one alkenyl group having 2 to 12 carbon atoms per molecule and free of a mercapto group-containing organic group; and
(A3) an organocompound having at least one mercapto group-containing organic group per molecule, in an amount that the mercapto groups in component (A3) is 0.1 to 3 moles per 1 mole of the sum of the acryl group-containing organic groups and/or methacryl group-containing organic groups in component (A1) and the alkenyl groups in component (A2).
Composition (M5):
(A6) an organopolysiloxane having at least one of an acryl group-containing organic group and/or a methacryl group-containing organic group per molecule, having at least one alkenyl group per molecule, and free of a mercapto group-containing organic group; and
(A3) an organocompound having at least one mercapto group-containing organic group per molecule, in an amount that the mercapto groups in component (A3) is 0 to 3 moles per 1 mole of the sum of the acryl group-containing organic groups and/or methacryl group-containing organic groups and the alkenyl groups in component (A6);
Composition (M6):
(A7) an organopolysiloxane having at least two alkenyl groups having 2 to 12 carbon atoms per molecule, and having at least two mercapto group-containing organic groups per molecule;
Composition (M7):
(A8) an organopolysiloxane having at least one of an acryl group-containing organic group and/or a methacryl group-containing organic group per molecule, having at least one alkenyl group having 2 to 12 carbon atoms per molecule, and having at least one mercapto group-containing organic group per molecule.

5. The photo-curable organopolysiloxane composition according to claim 1, wherein the photo-active organic group in component (B) is a group selected from the group consisting of groups represented by the following formulae (a) to (q): 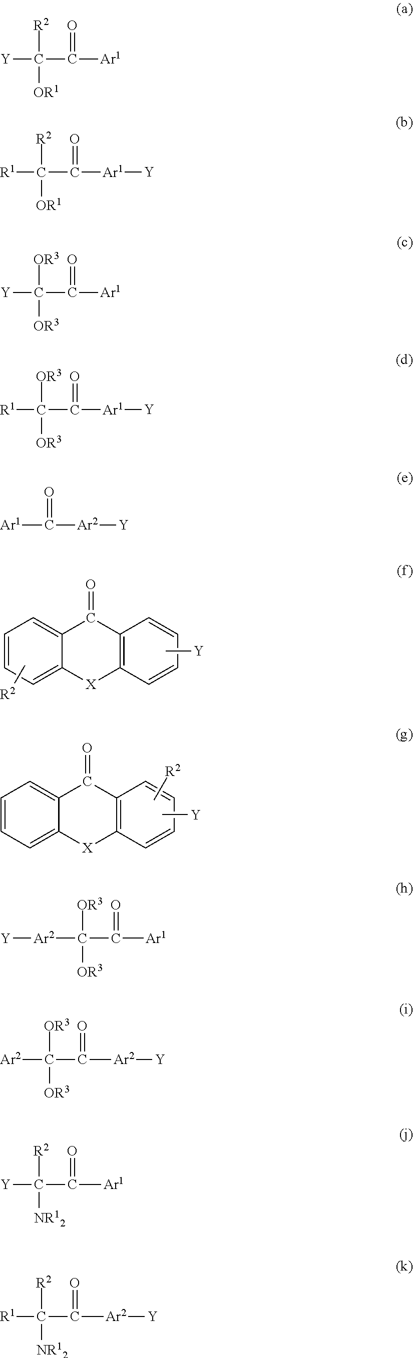 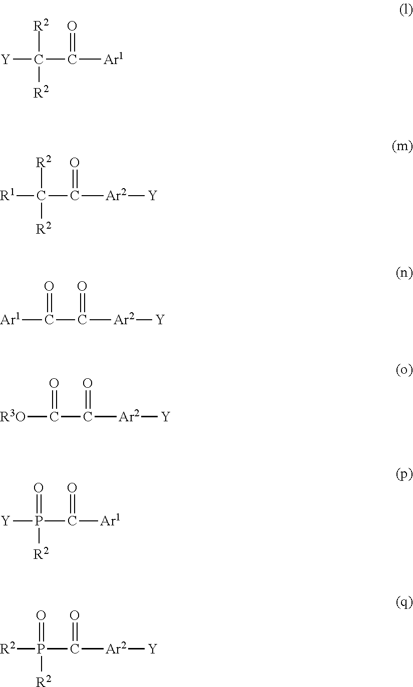
wherein R¹ is a hydrogen atom or an alkyl group having 1 to 12 carbon atoms; R² is an alkyl group having 1 to 12 carbon atoms, an aryl group having 6 to 20 carbon atoms, an aralkyl group having 7 to 20 carbon atoms, a halogen atom-, an amino group- or a hydroxyl group-substituted alkyl group having 1 to 12 carbon atoms, a halogen atom-, an amino group- or a hydroxyl group-substituted aryl group having 6 to 20 carbon atoms, or a halogen atom; R³ is an alkyl group having 1 to 12 carbon atoms; Ar¹ is an aryl group having 6 to 20 carbon atoms, or a halogen atom-, an amino group- or a hydroxyl group-substituted aryl group having 6 to 20 carbon atoms; Ar² is an arylene group having 6 to 20 carbon atoms, or a halogen atom-, an amino group- or a hydroxyl group-substituted arylene group having 6 to 20 carbon atoms; X is an oxygen atom or a sulfur atom; and Y is a divalent bond connecting with a Si atom in component (B).

6. The photo-curable organopolysiloxane composition according to claim 1, which is an optical or an electrical, and a pressure-sensitive adhesive, an adhesive, or an encapsulant.

7. A cured product obtained by exposing the photo-curable organopolysiloxane composition according to claim 1 to light of a wavelength of from 300 to 420 nm.
